(19) United States
(12) Patent Application Publication
(10) Pub. No.: US 2025/0159135 A1
(43) Pub. Date: May 15, 2025

(54) METHODS, SYSTEMS, AND STORAGE MEDIUMS FOR VIDEO ENCODING AND DECODING

(71) Applicant: ZHEJIANG DAHUA TECHNOLOGY CO., LTD., Hangzhou (CN)

(72) Inventors: Jucai LIN, Hangzhou (CN); Cheng FANG, Hangzhou (CN); Dong JIANG, Hangzhou (CN); Jun YIN, Hangzhou (CN)

(73) Assignee: ZHEJIANG DAHUA TECHNOLOGY CO., LTD., Hangzhou (CN)

(21) Appl. No.: 19/021,086

(22) Filed: Jan. 14, 2025

Related U.S. Application Data
(63) Continuation of application No. PCT/CN2023/107408, filed on Jul. 14, 2023.

(30) Foreign Application Priority Data
Jul. 14, 2022 (CN) 202210824946.4
Sep. 1, 2022 (CN) 202211064188.7
Nov. 21, 2022 (CN) 202211463044.9

(51) Int. Cl. H04N 19/105; H04N 19/182

(52) U.S. Cl. CPC H04N 19/105; H04N 19/182

(57) ABSTRACT

The embodiments of the present disclosure provide a method, system, and readable medium for video encoding. The method may include: obtaining current template reconstruction data, the current template reconstruction data including reconstruction pixel data of a current template region in a current frame related to a current encoding block; obtaining reference template reconstruction data, the reference template reconstruction data including reconstruction pixel data of a reference template region in a reference frame related to a reference encoding block, the current template region corresponding to the reference template region; obtaining a prediction value adjustment model of the current encoding block based on the current template reconstruction data and the reference template reconstruction data; obtaining an initial prediction value of the current encoding block; determining a target prediction value by adjusting, based on the initial prediction value, the initial prediction value according to the prediction value adjustment model; and determining encoding data of the current encoding block based on the target prediction value.

### CROSS-REFERENCE TO RELATED APPLICATIONS

This application is a continuation of International Application No. PCT/CN2023/107408, filed on Jul. 14, 2023, which claims priority to the Chinese Patent Application No. 202210824946.4, filed on Jul. 14, 2022, Chinese Patent Application No. 202211064188.7, filed on Sep. 1, 2022, and Chinese Patent Application No. 202211463044.9, filed on Nov. 21, 2022, the contents of each of which are hereby incorporated by reference.

### TECHNICAL FIELD

The present disclosure relates to a field of video encoding and decoding, in particular, related to methods, systems, and storage mediums for video encoding and decoding.

### BACKGROUND

Due to a relatively large amount of video image data, the video image data needs to be encoded and compressed before transmission or storage. Encoded data herein refers to a video code stream, and after obtaining the video code stream, a decoding end device may obtain the video by performing the corresponding decoding. Currently, when encoding the video image data, a linear prediction manner may be used. The linear prediction manner refers to constructing a linear model between a reference encoding block and a current encoding block and predicting a pixel value of the current encoding block through the linear model. Parameters of the linear model may be calculated by using reconstruction pixel values of adjacent reconstruction pixel points of the current encoding block and the reference encoding block.

Therefore, it is desired to provide methods and systems for video encoding and decoding, to realize a relatively good video encoding and decoding through a linear predictive process.

### SUMMARY

According to an aspect of the present disclosure, a video encoding method may be provided. The method may include: obtaining current template reconstruction data, the current template reconstruction data including reconstruction pixel data of a current template region in a current frame related to a current encoding block; obtaining reference template reconstruction data, the reference template reconstruction data including reconstruction pixel data of a reference template region in a reference frame related to a reference encoding block, the current template region corresponding to the reference template region; obtaining a prediction value adjustment model of the current encoding block based on the current template reconstruction data and the reference template reconstruction data; obtaining an initial prediction value of the current encoding block; determining a target prediction value by adjusting, based on the initial prediction value, the initial prediction value according to the prediction value adjustment model; and determining encoding data of the current encoding block based on the target prediction value.

According to another aspect of the present disclosure, a video encoding system may be provided. The system may include: at least one storage medium, the storage medium including an instruction set for a video encoding; at least one processor, the at least one processor being in communication with the at least one storage medium, wherein, when executing the instruction set, the at least one processor is configured to: obtain current template reconstruction data, the current template reconstruction data including reconstruction pixel data of a current template region in a current frame related to a current encoding block; obtain reference template reconstruction data, the reference template reconstruction data including reconstruction pixel data of a reference template region in a reference frame related to a reference encoding block, the current template region corresponding to the reference template region; obtain a prediction value adjustment model of the current encoding block based on the current template reconstruction data and the reference template reconstruction data; obtain an initial prediction value of the current encoding block; determine a target prediction value by adjusting, based on the initial prediction value, the initial prediction value according to the prediction value adjustment model; and determine encoding data of the current encoding block based on the target prediction value.

According to another aspect of the present disclosure, a non-transitory computer-readable storage medium, comprising a set of instructions, wherein when executed by a processor may be provided. The non-transitory computer-readable storage medium may include: obtaining current template reconstruction data, the current template reconstruction data including reconstruction pixel data of a current template region in a current frame related to a current encoding block; obtaining reference template reconstruction data, the reference template reconstruction data including reconstruction pixel data of a reference template region in a reference frame related to a reference encoding block, the current template region corresponding to the reference template region; obtaining a prediction value adjustment model of the current encoding block based on the current template reconstruction data and the reference template reconstruction data; obtaining an initial prediction value of the current encoding block; determining a target prediction value by adjusting, based on the initial prediction value, the initial prediction value according to the prediction value adjustment model; and determining encoding data of the current encoding block based on the target prediction value.

According to another aspect of the present disclosure, a video decoding method may be provided. The method may include: obtaining encoding data of a video, and obtaining video data by performing a decoding process corresponding to an encoding process on the encoding data, the encoding process including: obtaining current template reconstruction data, the current template reconstruction data including reconstruction pixel data of a current template region in a current frame related to a current encoding block; obtaining reference template reconstruction data, the reference template reconstruction data including reconstruction pixel data of a reference template region in a reference frame related to a reference encoding block, the current template region corresponding to the reference template region; obtaining a prediction value adjustment model of the current encoding block based on the current template reconstruction data and the reference template reconstruction data; obtaining an initial prediction value of the current encoding block; determining a target prediction value by adjusting, based on the initial prediction value, the initial prediction value according to the prediction value adjustment model; and determining encoding data of the current encoding block based on the target prediction value.

According to another aspect of the present disclosure, a video decoding system may be provided. The system may include: at least one storage medium, the storage medium including an instruction set for a video decoding; at least one processor, the at least one processor being in communication with the at least one storage medium, wherein when executing the instruction set, the at least one processor is configured to: obtain encoding data of a video, and obtain video data by performing a decoding process corresponding to an encoding process on the encoding data, the encoding process including: obtain current template reconstruction data, the current template reconstruction data including reconstruction pixel data of a current template region in a current frame related to a current encoding block; obtain reference template reconstruction data, the reference template reconstruction data including reconstruction pixel data of a reference template region in a reference frame related to a reference encoding block, the current template region corresponding to the reference template region; obtain a prediction value adjustment model of the current encoding block based on the current template reconstruction data and the reference template reconstruction data; obtain an initial prediction value of the current encoding block; determine a target prediction value by adjusting, based on the initial prediction value, the initial prediction value according to the prediction value adjustment model; and determine encoding data of the current encoding block based on the target prediction value.

According to another aspect of the present disclosure, a non-transitory computer-readable storage medium, comprising a set of instructions, wherein when executed by a processor may be provided. The non-transitory computer-readable storage medium may include: obtaining encoding data of a video, and obtaining video data by performing a decoding process corresponding to an encoding process on the encoding data, the encoding process including: obtaining current template reconstruction data, the current template reconstruction data including reconstruction pixel data of a current template region in a current frame related to a current encoding block; obtaining reference template reconstruction data, the reference template reconstruction data including reconstruction pixel data of a reference template region in a reference frame related to a reference encoding block, the current template region corresponding to the reference template region; obtaining a prediction value adjustment model of the current encoding block based on the current template reconstruction data and the reference template reconstruction data; obtaining an initial prediction value of the current encoding block; determining a target prediction value by adjusting, based on the initial prediction value, the initial prediction value according to the prediction value adjustment model; and determining encoding data of the current encoding block based on the target prediction value.

### BRIEF DESCRIPTION OF THE DRAWINGS

This specification will be further illustrated by way of exemplary embodiments, which will be described in detail with the accompanying drawings. These examples are non-limiting, and in these examples, the same number indicates the same structure, wherein:

FIG. 1 is a schematic diagram illustrating a video encoding system according to some embodiments of the present disclosure;

FIG. 2 is a schematic diagram illustrating exemplary hardware and/or software components of an exemplary computing device according to some embodiments of the present disclosure;

FIG. 3 is a block diagram illustrating an exemplary processing device according to some embodiments of the present disclosure;

FIG. 4 is a flowchart illustrating an exemplary process for video encoding according to some embodiments of the present disclosure;

FIG. 5 is a schematic diagram illustrating an exemplary structure of a current encoding block, a plurality of pixel rows, and a plurality of pixel columns according to some embodiments of the present disclosure;

FIG. 6 is a schematic diagram illustrating an exemplary process for performing a down-sampling on reconstruction pixels included in the pixel row and pixel column on the basic of FIG. 5 according to some embodiments of the present disclosure;

FIG. 7 is a schematic diagram illustrating an exemplary process for performing a down-sampling process on the reconstruction pixels included in the pixel row and pixel column on the basis of FIG. 5 according to some embodiments of the present disclosure;

FIG. 8 is a schematic diagram illustrating an exemplary process for performing a down-sampling process on the reconstruction pixels included in the pixel row and pixel column on the basis of FIG. 5 according to some embodiments of the present disclosure;

FIG. 9 is a schematic diagram illustrating an exemplary process for generating a plurality of windows on a current encoding block according to some embodiments of the present disclosure;

FIG. 10 is a schematic diagram of a horizontal direction of a Sobel operator according to some embodiments of the present disclosure;

FIG. 11 is a schematic diagram of a vertical direction of a Sobel operator according to some embodiments of the present disclosure;

FIG. 12 is a flowchart illustrating an exemplary process for determining a target prediction value of a current encoding pixel in a current encoding pixel type according to some embodiments of the present disclosure;

FIG. 13 is a schematic diagram illustrating an exemplary reference encoding block and reference template region according to some embodiments of the present disclosure;

FIG. 14 is a schematic diagram illustrating an exemplary current encoding block and current template region according to some embodiments of the present disclosure;

FIG. 15 is a flowchart illustrating an exemplary process for determining a target prediction value of a current encoding pixel according to some embodiments of the present disclosure;

FIG. 16 is a flowchart illustrating an exemplary process for determining a reference region according to some embodiments of the present disclosure;

FIG. 17 is a flowchart illustrating an exemplary process for generating a candidate reference region according to some embodiments of the present specification;

FIG. 18 is a flowchart illustrating an exemplary process for determining the target prediction value of the current encoding pixel according to some embodiments of the present disclosure;

FIG. 19 is a schematic diagram illustrating an exemplary initial reference encoding pixel and surrounding pixels of the initial reference encoding pixel according to some embodiments of the present disclosure;

FIG. 20 is a flowchart illustrating an exemplary process for determining the target prediction value of the current encoding pixel according to some embodiments of the present disclosure;

FIG. 21 is a schematic diagram illustrating a current encoding block and an initial current template region outside the current encoding block according to some embodiments of the present specification;

FIG. 22 is a flowchart illustrating an exemplary process for determining the current template region and a reference template region corresponding to FIG. 21 according to some embodiments of the present disclosure;

FIG. 23 is a flowchart illustrating an exemplary process for determining the target prediction value of the current encoding pixel according to some embodiments of the present disclosure;

FIG. 24 is a schematic diagram illustrating exemplary current encoding blocks of three color components and their respective reference encoding block, current template region, and reference template region according to some embodiments of the present disclosure;

FIG. 25 is a flowchart illustrating an exemplary process for determining the target prediction value of the current encoding pixel according to some embodiments of the present disclosure;

FIG. 26 is a flowchart illustrating an exemplary process for determining the target prediction value of the current encoding pixel according to some embodiments of the present disclosure;

FIG. 27 is a flowchart illustrating an exemplary process for determining the target prediction value of the current encoding pixel according to some embodiments of the present disclosure;

FIG. 28 is a flowchart illustrating an exemplary process for determining the target prediction value of the current encoding pixel according to some embodiments of the present disclosure; and

FIG. 29 is a flowchart illustrating an exemplary process for determining a target prediction value according to some embodiments of the present disclosure.

### DETAILED DESCRIPTION

In order to more clearly illustrate the technical solutions of the embodiments of the present specification, the following briefly introduces the drawings that need to be used in the description of the embodiments. Apparently, the accompanying drawings in the following description are only some examples or embodiments of this specification, and those skilled in the art can also apply this specification to other similar scenarios. Unless obviously obtained from the context or the context illustrates otherwise, the same numeral in the drawings refers to the same structure or operation.

It should be understood that “system”, “device”, “unit” and/or “module” as used herein is a method for distinguishing different components, elements, parts, parts or assemblies of different levels. However, the words may be replaced by other expressions if other words can achieve the same purpose.

As indicated in the specification and claims, the terms “a”, “an”, “an” and/or “the” are not specific to the singular and may include the plural unless the context clearly indicates an exception. Generally speaking, the terms “comprising” and “comprising” only suggest the inclusion of clearly identified steps and elements, and these steps and elements do not constitute an exclusive list, and the method or device may also contain other steps or elements.

The flowchart is used in this specification to illustrate the operations performed by the system according to the embodiment of this specification. It should be understood that the preceding or following operations are not necessarily performed in the exact order. Instead, various steps may be processed in reverse order or simultaneously. At the same time, other operations can be added to these procedures, or a certain step or steps can be removed from these procedures.

In a process of encoding and decoding video, in order to improve a compression rate and reduce codewords that need to be transmitted, an encoder may use an intra prediction mode or an inter prediction mode instead of encoding and transmitting pixel values directly. That is, a pixel value of a current encoding block may be predicted by using a reconstruction pixel from an encoded block of a current frame or a reference frame. The encoder may merely encode a certain prediction mode and a residual error generated when using the prediction mode. A decoder may decode the corresponding pixel value based on bitstream information, which can greatly reduce the required codewords for encoding. The pixel value predicted by the certain prediction mode is called a target prediction value, and a difference between the target prediction value and an original pixel value is called a residual.

In a video encoding process, an input encoder may be an image frame. When the encoder encodes an image frame, the image frame may be divided into a plurality of encoding units (CUs, which may also be called encoding blocks). For example the image frame may be divided into several largest encoding units (LCUs), and the LCU may be divided into the plurality of CUs. The video encoding may be performed in units of CU.

When encoding a certain image frame, each encoding block in the image frame may usually be encoded in a certain order, for example, each encoding block in the image frame may be encoded in the order from left to right and from top to bottom sequentially, or each encoding block in the image frame may be encoded in the order from right to left and from bottom to top sequentially. It should be understood that when encoding each encoding block in the image frame in order from left to right and from top to bottom, for any one of encoding block, the adjacent reconstruction pixels (e.g., predicted pixels) may be distributed on an upper side and a left side of the encoding block. When each encoding block is coded in order from right to left and from bottom to top sequentially, for any one of encoding block, the adjacent reconstruction pixels may be distributed on a lower side and a right side of the encoding block. For illustration conveniently, the encoding of each encoding block in the image frame is described below in order from left to right and from top to bottom.

For illustration conveniently, the encoding block being coded at a current moment may be defined as a current encoding block below. When encoding with an inter-frame prediction manner, the reference frame (which may be any coded image) may find a reference encoding block closest to the current encoding block through the manners such as a motion search and record motion information between the current encoding block and the reference coded block such as a motion vector (MV).

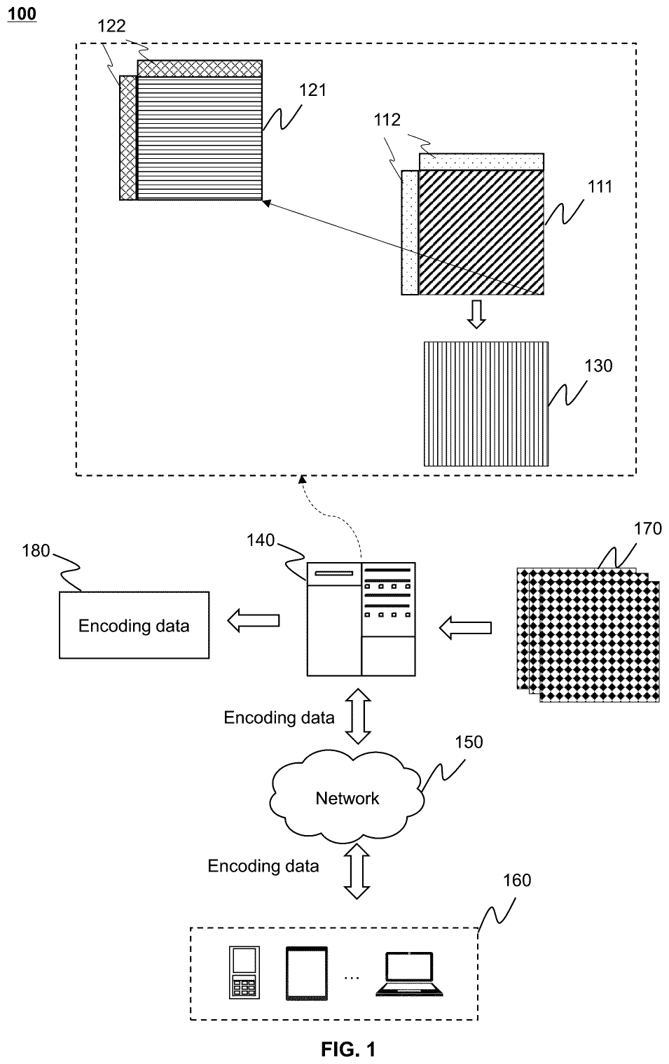

FIG. 1 is a schematic diagram illustrating a video encoding system 100 according to some embodiments of the present disclosure. In some embodiments, the video encoding system 100 may include a current encoding block 111, a current template region 112, a reference encoding block 121, a reference template region 122, a target prediction value 130, a processing device 140, a network 150, a terminal device 160, video data 170, and encoding data 180. In some embodiments, the video encoding system 100 may further include one or more other components such as a storage device (not shown in the figure).

The processing device 140 may be configured to obtain the video data 170, the video data 170 may include a plurality of image frames, and each image frame may include a plurality of encoding blocks. The encoding block may be a pixel region or pixel block obtained by dividing the image, which may include a plurality of pixels. A size of the pixel region may be various sizes set according to requirements (e.g., a pixel region may be a matrix composed of 16 pixels or a matrix composed of 9 pixels), the processing device may encode a pixel region as a unit, and the pixel region refers to an encoding block. The processing device 140 may be configured to obtain the encoded data 180 by encoding the video data 170. For example, the processing device 140 may perform the encoding manner described in some embodiments of the present disclosure to encode the video data 170.

The current encoding block 111 refers to an encoding block to be encoded currently. For example, as shown in FIG. 1, the current encoding block 111 is a portion filled with oblique lines.

The current template region 112 may include at least one reconstruction pixel around the current encoding block 111. For example, as shown in FIG. 1, the current template region 112 is a portion filled with dots.

The reference encoding block 121 refers to an encoding block closest to the current encoding block 111 in a coded image frame. For example, as shown in FIG. 1, the reference encoding block 121 is a portion filled with horizontal lines.

The reference template region 122 may include at least one reconstruction pixel around the reference encoding block 121. For example, as shown in FIG. 1, the reference template region 122 is a portion filled with grids.

The target prediction value 130 refers to an encoding block obtained after predicting the current encoding block 111. For example, as shown in FIG. 1, the target prediction value 130 is a portion filled with vertical lines.

In some embodiments, more specifically, encoding the video data 170 by the processing device 140 may include obtaining the target prediction value 130 by performing video encoding on the current encoding block 111. For example, the processing device 140 may obtain a prediction value adjustment model of the current encoding block 111 based on reconstruction pixel data of the current template region 112 and reconstructed pixel data of the reference template region 122. The processing device 140 may obtain an initial prediction value of the current encoding block 111 and determine the target prediction value 130 based on the initial prediction value through the above prediction value adjustment model.

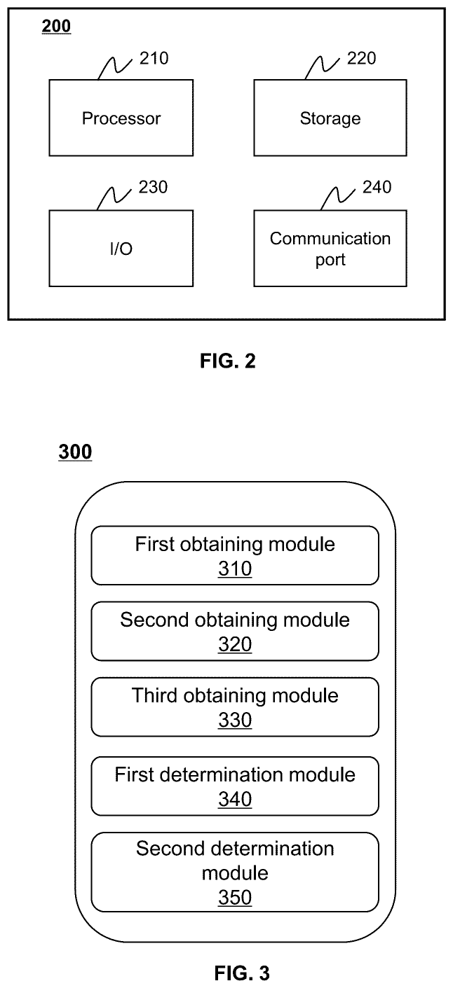

In some embodiments, the processing device 140 may be a single server or a server group. The server group may be centralized or distributed. In some embodiments, the processing device 140 may be local or remote. In some embodiments, the processing device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the processing device 140 may be implemented by a computing device 200 having one or more components illustrated in FIG. 2.

The network 150 may include any suitable network that facilitates the exchange of information and/or data. For example, the processing device 140 and the terminal device 160 (or the storage device, etc.) may communicate information and/or data via the network.

In some embodiments, the network may be or include a public network (e.g., the Internet), a private network (e.g., a local region network (LAN)), a wired network, a wireless network (e.g., an 802.11 network, a Wi-Fi network), a frame relay network, a virtual private network (VPN), a satellite network, a telephone network, routers, hubs, switches, server computers, and/or any combination thereof. For example, the network may include a cable network, a wireline network, a fiber-optic network, a telecommunications network, an intranet, a wireless local region network (WLAN), a metropolitan region network (MAN), a public telephone switched network (PSTN), a Bluetooth™ network, a ZigBee™ network, a near field communication (NFC) network, or the like, or any combination thereby. In some embodiments, the network may include one or more network access points. For example, the network may include wired and/or wireless network access points such as base stations and/or internet exchange points through which one or more components of the video encoding system 100 may be connected to the network to exchange data and/or information.

In some embodiments, the encoding data 180 of the video data 170 obtained by the processing device 140 may be transmitted to other devices (e.g., the terminal device 160) via the network. In some embodiments, other devices (e.g., the terminal device 160) may obtain restored video data by performing corresponding decoding processing on the encoding data 180 after obtaining the encoding data 180.

In some embodiments, the user may interact with the video encoding system 100 via the terminal device 160. In some embodiments, the processing device 140 may be a part of the terminal device. In some embodiments, the terminal device may include an embedded device with a relatively small storage capacity. In some embodiments, the terminal device may include a smart phone, a smart camera, a smart audio, a smart TV, a smart fridge, a robot, a tablet, a laptop, a wearable, a payment device, a cashier device, or any combination thereof.

In some embodiments, the video encoding system 100 may also include some or more other devices, for example, the storage device (not shown in the figure).

The storage device may store data, instructions, and/or any other information. In some embodiments, the storage device may store data and/or instructions related to video encoding. For example, the storage device may store the current encoding block 111. As another example, the storage device may store instructions for processing the current encoding block 111 for video encoding. In some embodiments, the storage device may include a mass storage, removable storage, a volatile read-and-write memory, a read-only memory (ROM), or the like, or any combination thereof. In some embodiments, the storage device may be implemented on a cloud platform. In some embodiments, the storage device may be integrated into the processing device 140 and/or the terminal device.

In some embodiments, the storage device may be connected with the network to communicate with one or more other components in the video encoding system 100 (e.g., the processing device 140, the terminal device 160, etc.). The one or more components of the video encoding system 100 may access data or instructions stored in the storage device via the network. In some embodiments, the storage device may be a part of the processing device 140.

It should be noted that the above description regarding the video encoding system 100 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the video encoding system 100 may include one or more additional components, and/or one or more components of the video encoding system 100 described above may be omitted. Additionally or alternatively, two or more components of the video encoding system 100 may be integrated into a single component. A component of the video encoding system 100 may be implemented on two or more sub-components.

FIG. 2 is a schematic diagram illustrating exemplary hardware and/or software components of an exemplary computing device according to some embodiments of the present disclosure. In some embodiments, the processing device 140 and/or the terminal device may be implemented on the computing device 200. As illustrated in FIG. 2, the computing device 200 may include a processor 210, a storage 220, an input/output (I/O) 230, and a communication port 240.

The processor 210 may execute computer instructions (e.g., program code) and perform functions of the processing device 140 in accordance with techniques describable herein. The computer instructions may include, for example, routines, programs, objects, components, data structures, procedures, modules, and functions, which perform particular functions describable herein.

In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor is describable in the computing device 200. However, it should be noted that the computing device 200 in the present disclosure may also include multiple processors, thus operations and/or method operations that are performed by one processor as describable in the present disclosure may also be jointly or separately performed by the multiple processors. For example, if in the present disclosure, the processor of the computing device 200 executes both operation A and operation B, it should be understood that operation A and operation B may also be performed by two or more different processors jointly or separately in the computing device 200 (e.g., a first processor executes operation A and a second processor executes operation B, or the first and second processors jointly execute operations A and B).

The storage 220 may store data obtained from one or more components of the model processing system 100. In some embodiments, the storage 220 may include a mass storage device, a removable storage device, a volatile read-and-write memory, a read-only memory (ROM), or the like, or any combination thereof. In some embodiments, the storage 220 may store one or more programs and/or instructions to perform exemplary methods describable in the present disclosure. For example, the storage 220 may store a program for the processing device 140 to execute to compress the machine learning model.

The I/O 230 may input and/or output signals, data, information, etc. In some embodiments, the I/O 230 may enable a user interaction with the processing device 140. In some embodiments, the I/O 230 may include an input device and an output device. The input device may include a keyboard, a touch screen, a speech input, an eye tracking input, a brain monitoring system, or any other comparable input mechanism. The input information received through the input device may be transmitted to another component (e.g., the processing device 140) via, for example, a bus, for further processing. Other types of input devices may include a cursor control device, such as a mouse, a trackball, or cursor direction keys, etc. The output device may include a display (e.g., a liquid crystal display (LCD), a light-emitting diode (LED)-based display, a flat panel display, a curved screen, a television device, a cathode ray tube (CRT), a touch screen), a speaker, a printer, or the like, or a combination thereof.

The communication port 240 may be connected to a network (e.g., the network 130) to facilitate data communications. The communication port 240 may establish connections between the processing device 140 and the terminal device. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee™ link, a mobile network link (e.g., 3G, 4G, 5G), or the like, or a combination thereof. In some embodiments, the communication port 240 may be and/or include a standardized communication port, such as RS232, RS485, etc. In some embodiments, the communication port 240 may be a specially designed communication port.

FIG. 3 is a block diagram illustrating an exemplary processing device according to some embodiments of the present disclosure. In some embodiments, the processing device 140 may include a first obtaining module 310, a second obtaining module 320, a third obtaining module 330, a first determination module 340, and a second determination module 350.

The first obtaining module 310 may be configured to obtain current template reconstruction data, where the current template reconstruction data may include reconstruction pixel data of a current template region in a current frame related to a current encoding block.

The second obtaining module 320 may be configured to obtain reference template reconstruction data, the reference template reconstruction data may include reconstruction pixel data of a reference template region in a reference frame related to a reference encoding block, the current template region corresponding to the reference template region.

The third obtaining module 330 may be configured to obtain a prediction value adjustment model of the current encoding block based on the current template reconstruction data and the reference template reconstruction data.

The first determination module 340 may be configured to an initial prediction value of the current encoding block and determining a target prediction value by adjusting, based on the initial prediction value, the initial prediction value according to the prediction value adjustment model.

The second determining module 350 may be configured to determine the encoding data of the current encoding block based on the target prediction value.

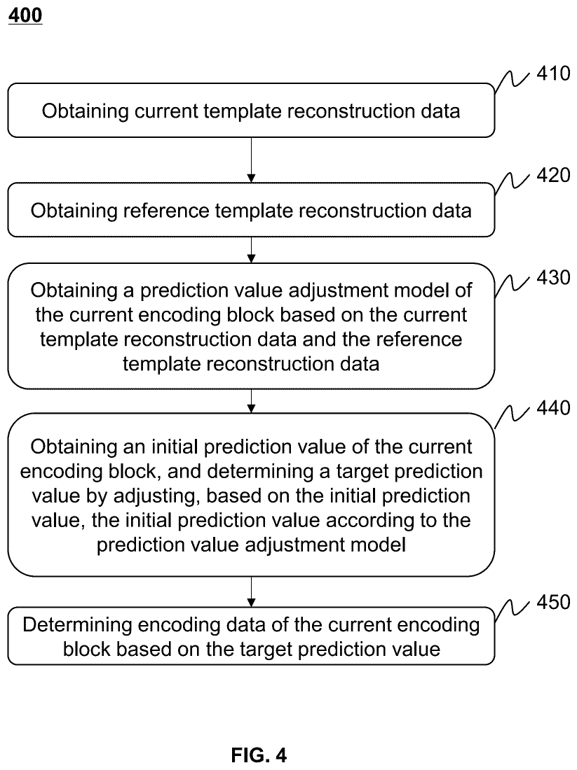

More descriptions of the first obtaining module 310, the second obtaining module 320, the third obtaining module 330, the first determination module 340, and the second determination module 350 may be found in FIGS. 4-29 and the related descriptions.

It should be noted that the above descriptions of processing device 140 are provided for the purposes of illustration, and not intended to limit the scope of the present disclosure. For persons having ordinary skills in the art, various modifications and changes in the forms and details of the application of the above method and system may occur without departing from the principles of the present disclosure. In some embodiments, processing device 140 may include one or more other modules and/or one or more modules described above may be omitted. Additionally or alternatively, two or more modules may be integrated into a single module and/or a module may be divided into two or more units. However, those variations and modifications also fall within the scope of the present disclosure.

FIG. 4 is a flowchart illustrating an exemplary process for video encoding according to some embodiments of the present disclosure. In some embodiments, process 400 may be executed by the video encoding system 100. For example, the process 400 may be implemented as a set of instructions stored in a storage device. In some embodiments, the processing device 140 (e.g., the processor 210 of the computing device 200 and/or one or more modules illustrated in FIG. 3) may execute the set of instructions and may accordingly be directed to perform the process 400. The operations of the illustrated process presented below are intended to be illustrative. In some embodiments, the process 400 may be accomplished with one or more additional operations not described and/or without one or more of the operations discussed. Additionally, the order of the operations of process 400 illustrated in FIG. 4 and described below is not intended to be limiting.

In 410, current template reconstruction data is obtained. The operation 410 may be performed by the first obtaining module 310.

The current template reconstruction data may include reconstruction pixel data of a current template region related to a current encoding block in a current frame.

The video may be composed of a series of single still images called “frames” in succession. The current frame refers to a single still image to be encoded currently.

The current encoding block refers to the encoding block to be coded currently. In some embodiments, the current encoding block may be a luma block or a chrominance block.

The current template region may include at least one reconstruction pixel around the current encoding block. In some embodiments, the processing device may determine the current template region through various manners.

The reconstruction pixel data refers to pixel data obtained by decoding encoding data of encoded encoding block. The reconstruction pixel data of the current template region refers to pixel data obtained by decoding encoding data of encoded current template region.

In some embodiments, the processing device may designate a pixel region formed by at least one pixel column along a direction pointed out from an outside of the current encoding block as the current template region, the at least one pixel column may start from an adjacent pixel column of the current encoding block on the outside; and/or, designate a pixel region formed by at least one pixel row along a direction pointed out from an outside of the current encoding block as the current template region, the at least one pixel row may start from an adjacent pixel row of the current encoding block on the outside.

A plurality of pixel rows may be determined outside a first side of the current encoding block, and a plurality of pixel columns may be determined outside a second side of the current encoding block. The first side and the second side may be adjacently arranged, and both the pixel row and pixel column may include a plurality of reconstruction pixels.

Specifically, both the pixel row and the pixel column may include the plurality of reconstruction pixels. When encoding each encoding block in the image frame in order from left to right and from top to bottom, an outer side of the first side may be an upper side of the current encoding block, and an outer side of the second side may be a left side of the current encoding block; when encoding each encoding block in the image frame in order from right to left and from bottom to top, the outer side of the first side may be a lower side of the current encoding block, and the outer side of the second side is a right side of the current encoding block. For illustration conveniently, in the following descriptions, the outside of the first side is referred to as the upper side of the current encoding block and the outside of the second side is referred to as the left side of the current encoding block.

The both ends of the pixel row distributed on the upper side of the current encoding block may be flush with the both ends of the current encoding block in a width direction, respectively, i.e., a length of the pixel row distributed on the upper side of the current encoding block may be equal to a width of the current encoding block, the both ends of the pixel column distributed on the left side of the current encoding block may be flush with the both ends of the current encoding block in a height direction, respectively, i.e., a length of the pixel column distributed on the left side of the current encoding block may be equal to a height of the current encoding block.

In some embodiments, the processing device may select a pixel row on the upper side of the current encoding block and a pixel column on the left side of the current encoding block. Considering the richness of the image and using more spatial domain information, the processing device may determine a plurality of pixel columns on the left side of the current encoding block and a plurality of pixel rows on the upper side.

If the count of pixel rows is recorded as m and the count of pixel columns is recorded as n, where m and n may or may not be equal.

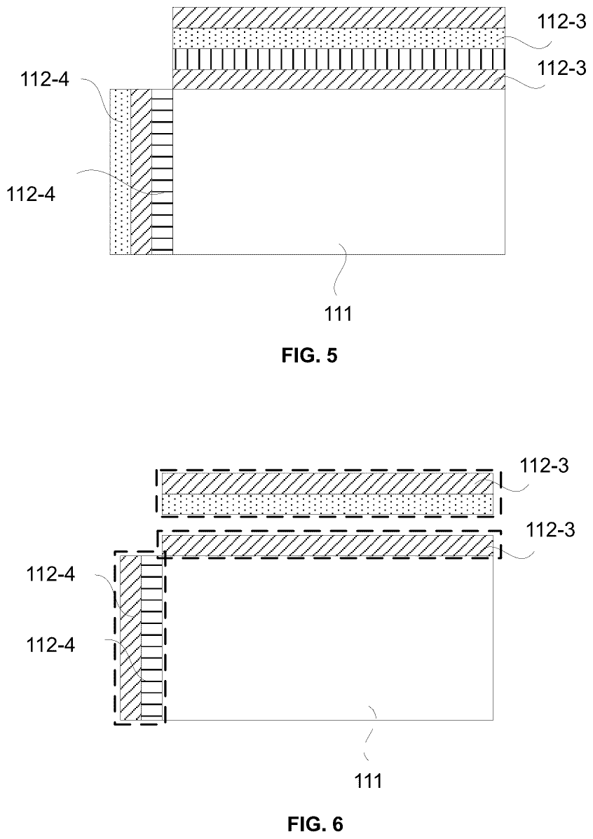

FIG. 5 is a schematic diagram illustrating an exemplary structure of a current encoding block, a plurality of pixel rows, and a plurality of pixel columns according to some embodiments of the present disclosure. In some embodiments, as shown in FIG. 5, the plurality of pixel rows (represented by 112-3 in FIG. 5) are continuous pixel rows and the plurality of pixel columns (represented by 112-4 in FIG. 5) are continuous pixel columns, i.e., there are no other reconstruction pixels between two adjacent pixel columns or two adjacent pixel columns. At the same time, there are no other reconstruction pixels between the plurality of pixel rows and the current encoding block (indicated by 111 in FIG. 5) and there are no other reconstruction pixels between the plurality of pixel columns and the current encoding block.

In some embodiments, considering that the greater the count of current encoding pixels in the current encoding block, the more spatial domain information is required to determine a reference relationship between the current encoding block and the reference encoding block. Therefore, in order to determine a relationship between the current encoding block and the reference encoding block accurately, the processing device may set that: a count of the at least one pixel column is positively correlated with a size of the current encoding block, and/or a count of the at least one pixel row is positively correlated with the size of the current encoding block.

The total count of pixel rows and pixel columns may be positively correlated with the size of the current encoding block. The size of the current encoding block may be represented by the count of current encoding pixels in the current encoding block.

Specifically, the word “positively correlated with” herein may indicate that the larger the size of the current encoding block, the larger the total count of pixel rows and pixel columns, or: as the size of the current encoding block increases, the total count of pixel rows and pixel columns may also increase as a whole.

In some embodiments, the total count of pixel rows and pixel columns may also be independent of the size of the current encoding block. For example, regardless of the size of the current encoding block, the total count of pixel rows and pixel columns may be set to M (e.g., 4, 5, 6, etc.).

In some embodiments, in response to a width of the current encoding block being equal to a height of the current encoding block, the processing device may set the count of at least one pixel column to be the same as the count of at least one pixel row. In response to the width of the current encoding block being greater than the height of the current encoding block, the processing device may set the count of at least one pixel row to be greater than the count of at least one pixel column. In response to the width of the current encoding block being less than the height of the current encoding block, the processing device may set the count of at least one pixel row to be less than the count of at least one pixel column.

It can be understood that the width of the current encoding block being equal to the height of the current encoding block means that the count of adjacent reconstruction pixels on the left side of the current encoding block is equal to the count of adjacent reconstruction pixels on the upper side of the current encoding block, so a connection degree between the current encoding block and the adjacent reconstruction pixel on the left side may be the same as a connection degree between the current encoding block and the adjacent reconstruction pixel on the upper side, so the count of at least one pixel column may be set to be the same the count of at least one pixel row. The width of the current encoding block being greater than the height of the current encoding block means that the count of adjacent reconstruction pixels on the upper side of the current encoding block is greater than the count of adjacent reconstruction pixels on the left side of the current encoding block, so the connection degree between the current encoding block and the adjacent reconstruction pixel on the upper side is greater than the connection degree with the current encoding block and the adjacent reconstruction pixel on the left side, and the count of at least one pixel row may be set to be greater than the count of at least one pixel column. The width of the current encoding block being less than the height of the current encoding block means that the count of adjacent reconstruction pixels on the upper side of the current encoding block is less than the count of adjacent reconstruction pixels on the left side of the current encoding block, so the connection degree between the current encoding block and the adjacent reconstruction pixel on the upper side is less than the connection degree between the current encoding block and the adjacent reconstruction pixel on the left side, and the count of at least one pixel row may be set to be less than the count of at least one pixel column.

For example, as shown in FIG. 5, the size of the current encoding block 111 may be 16×8. According to the above scheme, the processing device may set the count of pixel rows 112-3 to be greater than the count of pixel columns 112-4 (e.g., the count of pixel rows 112-3 may be 3, and the count of pixel columns 112-4 may be 3).

In some embodiments, regardless of the width and height of the current encoding block, the processing device may directly set the count of at least one pixel column to be the same as the count of at least one pixel row, directly set the count of at least one pixel row to be greater than at least one pixel column, or directly set the count of at least one pixel row to be less than the count of at least one pixel column.

In some embodiments, the processing device may construct the current template by using a pixel region formed by the at least one pixel column and/or a pixel region formed by the at least one pixel row.

In some embodiments, the processing device may extract, a portion of current template pixels from the pixel region formed by the at least one pixel column and/or the pixel region formed by the at least one pixel row. The processing device may construct the current template region using the portion of the current template pixels. That is to say, after forming the pixel region formed by the at least one pixel column and/or the pixel region formed by the at least one pixel row, a down-sampling processing may be reduced, which can reduce computational complexity.

In some embodiments, the processing device may extract a portion of the pixel columns from at least one pixel column; and/or extract a portion of pixel rows from at least one pixel row. The portion of current template pixels may be determined by extracting the current template pixels included in the portion of the pixel columns and the portion of pixel rows.

For example, as shown in FIG. 5 and FIG. 6, FIG. 6 is a schematic diagram illustrating an exemplary process for performing a down-sampling on reconstruction pixels included in the pixel row and pixel column on the basic of FIG. 5 according to some embodiments of the present disclosure. After determining the pixel row and pixel column as shown in FIG. 5, a few pixel rows and pixel columns may be extracted (the pixel rows and pixel columns selected in the dashed box of FIG. 6 may be the extracted pixel rows and columns), and the portion of current template pixels may be determined by using the current template pixels included in the extracted pixel rows and pixel columns.

When extracting the pixel rows and/or pixel columns, the extraction process may be continuous or discontinuous. The continuous extraction process refers to that there are no other reconstruction pixels between the extracted adjacent two pixel rows or pixel columns, and the discontinuous extraction process refers to that there is other reconstructed pixel between the extracted adjacent two pixel rows or pixel columns.

In some embodiments, the processing device may extract a portion of pixel rows and/or pixel columns according to a preset rule. For example, the processing device may randomly extract the portion of pixel rows and/or pixel columns.

In some embodiments, the processing device may extract a current template pixel at a preset position from the current template pixels included in at least one pixel column; and/or extract a current template pixel at the preset position from the current template pixels included in at least one pixel row. For example, the processing device may preset a position of the reconstruction pixel to be extracted relative to the current encoding block, and perform the extraction process according to the preset position. In response to the current encoding blocks being different, and the preset position corresponding to the current encoding blocks may be the same or different.

In some embodiments, the processing device may extract a current template pixel from at least one pixel row along an extension direction of the upper side according to a preset pixel column interval; and/or, extract a current template pixel from at least one pixel column along an extension direction on the left side according to a preset pixel row interval.

In some embodiments, the processing device may only extract the reconstruction pixels included in at least one pixel row, extract the reconstruction pixels included in at least one pixel column, or extract the reconstruction pixels included both in at least one pixel row and at least one pixel column. For illustration conveniently, in the following descriptions, both the reconstruction pixels included in at least one pixel row and the reconstruction pixels included in at least one pixel column may be extracted.

In some embodiments, a pixel interval for extracting the reconstruction pixels in at least one pixel row (i.e., a preset pixel column interval) and a pixel interval for extracting the reconstruction pixels in at least one pixel column (i.e., a preset pixel row interval) may be the same or different.

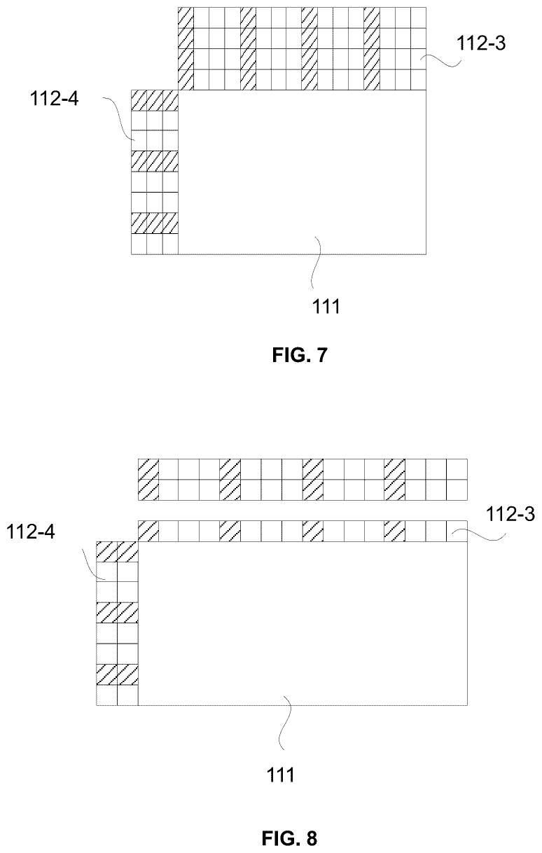

For example, combined with FIG. 5 and FIG. 7, FIG. 7 is a schematic diagram illustrating an exemplary process for performing a down-sampling process on the reconstruction pixels included in the pixel row and pixel column on the basis of FIG. 5 according to some embodiments of the present disclosure. In FIG. 7, the pixels filled with oblique lines may be an extracted portion of current template region, and the current template region may be constructed by using the reconstruction pixels filled with oblique lines. That is to say, the preset pixel column interval for extracting the reconstruction pixels in at least one pixel row may be 3 reconstruction pixels, and the preset pixel row interval for extracting the reconstruction pixels in at least one pixel row may be 2 reconstruction pixels, the preset pixel column interval and the preset pixel row interval are not the same.

In some embodiments, the processing device may construct the current template region by combining the above manners of extracting a portion of the current template pixels. For example, the processing device may extract a portion of pixel rows and/or pixel columns from at least one pixel row and/or at least one pixel column, and extract reconstruction pixels at the preset position from a portion of the pixel rows and/or pixel columns.

In some embodiments, the processing device may extract a portion of pixel rows and/or pixel columns from at least one pixel row and/or at least one pixel column, extract the current template pixel from at least one pixel row according to the preset pixel column interval along the extension direction of the upper side, and/or, extract the current template pixel from at least one pixel column according to the preset pixel row interval along the extension direction of the left side. For example, as shown in FIG. 5 and FIG. 8, FIG. 8 is a schematic diagram illustrating an exemplary process for performing a down-sampling process on the reconstruction pixels included in the pixel row and pixel column on the basis of FIG. 5 according to some embodiments of the present disclosure, at this time, a portion of the pixel rows and pixel columns may be extracted, and then the reconstruction pixels may be extracted from the extracted pixel rows along the extension direction of the upper side according to the preset pixel row interval, the reconstruction pixels may be extracted from the extracted pixel rows along the extension direction of the left side according to the preset pixel row interval, and finally the pixels filled with oblique lines in FIG. 8 may be the extracted portion of reconstruction pixels, and the current template region may be constructed using the reconstruction pixels filled with oblique lines.

In some embodiments, the processing device may obtain a plurality of candidate current template regions of the current encoding block, and select a combination of at least one of the plurality of candidate current template regions as the current template region based on target features of the current encoding block.

In some embodiments, the candidate current template regions may include a first template region, a second template region, and a third template region.

The first template region refers to the current template pixel(s) distributed on a first side and a second side of the current encoding block. That is to say, when the current template region of the current encoding block is the first template region, the current template pixel(s) in the current template region may be distributed on the first side and the second side of the current encoding block.

The second template region refers to the current template pixel(s) distributed on the first side of the current encoding block. That is to say, when the current template region of the current encoding block is the second template region, the current template pixel(s) in the current template region may be distributed on the first side of the current encoding block. For illustration conveniently, in the following descriptions, when the current template region of the current encoding block is the second template region, an arrangement direction of the current template pixel(s) in the current template region may be parallel to the width direction of the current encoding block, that is to say, the current template pixel(s) in the current template region may be composed of the pixel row.

The third template region refers to the current template pixel(s) distributed on the second side of the current encoding block. That is to say, when the current template region of the current encoding block is the third template region, the current template pixel(s) in the current template region is distributed on the second side of the current encoding block. For illustration conveniently, in the following descriptions, when the current template region of the current encoding block is the third template region, the arrangement direction of the current template pixel(s) in the current template region may be parallel to the height direction of the current encoding block. That is to say, the current template pixel(s) in the current template region may be composed of the pixel column.

It can be understood that when encoding each encoding block in the image frame in order from left to right and from top to bottom, the first side may be the upper side of the current encoding block and the second side may be the left side of the current encoding block. When encoding each encoding block in the image frame in order from right to left and bottom to top, the first side may be the lower side of the current encoding block and the second side may be the right side of the current encoding block. For illustration conveniently, in the following descriptions, the first side may be the upper side of the current encoding block and the second side may be the left side of the current encoding block. That is to say, the arrangement direction of a portion of the current template pixels in the first template region may be parallel to the width direction of the current encoding block, and the arrangement direction of another portion of the current template pixels may be parallel to the height direction of the current encoding block; the arrangement direction of the current template pixels in the second template region may be parallel to the width direction of the current encoding block; the arrangement direction of the current template pixels in the third template region may be parallel to the height direction of the current encoding block.

In the prior art, when determining the current template region of the current encoding block, the processing device may directly determine the current template region of the current encoding block as the first template region. However, in fact, the image has diversity, in some images, the current encoding block may be inseparable from regions on the left and upper side, in some images, the current encoding block may be only connected with region on the left side or only with region on the upper side. While the current template of the current encoding block is directly determined as the first template region, the actual situation of the image may be inconsistent. Therefore, in some embodiments, the processing device may determine the current template region of the current encoding block according to at least one of a size and/or a texture direction of the current encoding block.

The target feature refers to feature that can reflect a connection between the current encoding block and the side. In some embodiments, the target feature may include a size of the current encoding block and/or a texture direction of the current encoding block, or the like. The size of the current encoding block may include the width of the current encoding block and the height of the current encoding block, and the texture direction of the current encoding block may include a horizontal direction and a vertical direction.

In some embodiments, in response to a ratio of the width of the current encoding block to the height of the current encoding block being greater than a first threshold, the processing device may determine the current template region of the current encoding block as the second template region. The first threshold may be greater than 1.

In some embodiments, in response to the ratio of the height of the current encoding block to the width of the current encoding block being greater than a second threshold, the processing device may determine the current template region of the current encoding block as the third template region. The second threshold may be greater than 1.

In some embodiments, in response to the ratio of the width of the current encoding block to the height of the current encoding block being less than or equal to the first threshold and the ratio of the height of the current encoding block to the width of the current encoding block being less than or equal to the second threshold, the processing device may determine the current template region of the current encoding block as the first template region.

Specifically, when the ratio of the width of the current encoding block to the height of the current encoding block is greater than the first threshold, the width of the current encoding block is greater than the height of the current encoding block, and the count of adjacent reconstruction pixels on the upper side of the current encoding block is greater than the count of adjacent reconstruction pixels on the left side of the current encoding block, so the adjacent reconstruction pixels on the upper side of the current encoding block have more influence on the current encoding block than the adjacent reconstruction pixels on the left side of the current encoding block, the current template region may be constructed by using adjacent reconstruction pixels located on the upper side of the current encoding block. Based on similar reasons, when the ratio of the height of the current encoding block to the width of the current encoding block is greater than the second threshold, the current template region may be constructed by using adjacent reconstruction pixels on the left side of the current encoding block, and when the ratio of the width of the current encoding block to the height of the current encoding block is less than or equal to the first threshold of the current encoding block and the ratio of height to width of the current encoding block is less than or equal to the second threshold, the adjacent reconstruction pixels on the upper side of the current encoding block and the adjacent reconstruction pixels on the left side of the current encoding block may be configured to construct the current template region.

For example, assuming that the first threshold is 2 and the second threshold is 4, if the size of the current encoding block is 16×4, the ratio of the width of the current encoding block to the height of the current encoding block is 4, which is greater than the first threshold, the current encoding block of the current template region may be designated as the second template region, that is to say, the current template may be constructed by using adjacent reconstruction pixels on the upper side of the current encoding block. If the size of the current encoding block is 4×32, the ratio of the height of the current encoding block to the width of the current encoding block is 8 at this time, which is greater than the second threshold, the current template region of the current encoding block may be designated as the third template region, that is to say, the current template region may be constructed by using adjacent reconstruction pixels on the left side of the current encoding block. If the size of the current encoding block is 8×4, the ratio (which is equal to 2) of the width of the current encoding block to the height of the current encoding block is less than or equal to the first threshold (which is equal to 2) and the ratio (which is equal to 0.5) of the height of the current encoding block to the width of the current encoding block is less than or equal to the second threshold (which is equal to 4), the current template region may be constructed by simultaneously using the adjacent reconstruction pixels on the upper side and the left side.

In the application scenario, when determining the current template region of the current encoding block according to the size of the current encoding block, because the decoder can know a size of the encoding block, the decoder may directly determine a template type when the decoder performs the encoding process according to the size of the encoding block, that is to say, the encoder does not need to transmit additional syntactic elements when transmitting the code stream. However, in order to reduce the computational complexity of the decoder, the encoder may also add a syntactic element when the decoder transmits, the syntactic element may indicate that the encoder determines whether the current template region of the current encoding block is the first template region, the second template region, or the third template region during the encoding. Specifically, the syntactic element may include a first identifier. When the current template region is the first template region, a value of the first identifier may be a first value. When the current template region is the second template region, the value of the first identifier may be a second value. When the current template region is the third template region, the value of the first identifier may be a third value, that is to say, the value of the first identifier may be associated with a type of the current model.

In some embodiments, in response to the texture direction of the current encoding block being a horizontal direction, the processing device may determine the current template region of the current encoding block as the third template region. In response to the texture direction of the current encoding block being a vertical direction, the processing device may determine the current template region of the current encoding block as the second template region; otherwise, the processing device may determine the current template region of the current encoding block as the first template region.

The texture direction of the current encoding block is the horizontal direction, which indicates that the pixels in the current encoding block and the pixels on the left side of the current encoding block have a relatively high probability of belonging to a same object, and the pixels on the left side of the current encoding block have a relatively high impact on the current encoding block. Therefore, the current template region may be constructed by using adjacent reconstruction pixels on the left side of the current encoding block. Based on similar reasons, the texture direction of the current encoding block is the vertical direction, which indicates that the pixels in the current encoding block and the pixels on the upper side of the current encoding block have a relatively high probability of belonging to the same object, the pixels on the upper side of the current encoding block have a relatively high impact on the current encoding block. Therefore, the current template region may be constructed by using adjacent reconstruction pixels on the upper side of the current encoding block. The texture direction of the current encoding block is neither horizontal nor vertical, and the adjacent reconstruction pixels on the upper side of the current encoding block and the adjacent reconstruction pixels on the left side of the current encoding block may be configured to construct the current template region at the same time.

In some embodiments, the processing device may generate a plurality of windows on the current encoding block, each window may frame a portion of pixels in the current encoding block, and the pixels framed by different windows may be not completely the same. The processing device may determine the texture direction of the current encoding block in each window respectively, and obtain the texture direction corresponding to each window. The processing device may determine a first ratio between the count of first windows whose corresponding texture direction is the horizontal direction and the total count of the plurality of windows. The processing device may determine a second ratio between the count of second windows whose corresponding texture direction is the vertical direction and the total count of the plurality of windows. In response to the first ratio being greater than or equal to a third threshold and the second ratio being less than a fourth threshold, the texture direction of the current encoding block may be determined as the horizontal direction. In response to the first ratio being less than a fifth threshold and the second ratio being greater than or equal to a sixth threshold, the texture direction of the current encoding block may be determined as the vertical direction. Otherwise, the texture direction of the current encoding block may be determined as neither the horizontal direction nor the vertical direction.

The size of the window may be less than the size of the current encoding block, and different windows may frame different regions of the current encoding block. The sizes of the plurality of windows generated at the same time may or may not be completely the same, which may be set according to actual needs.

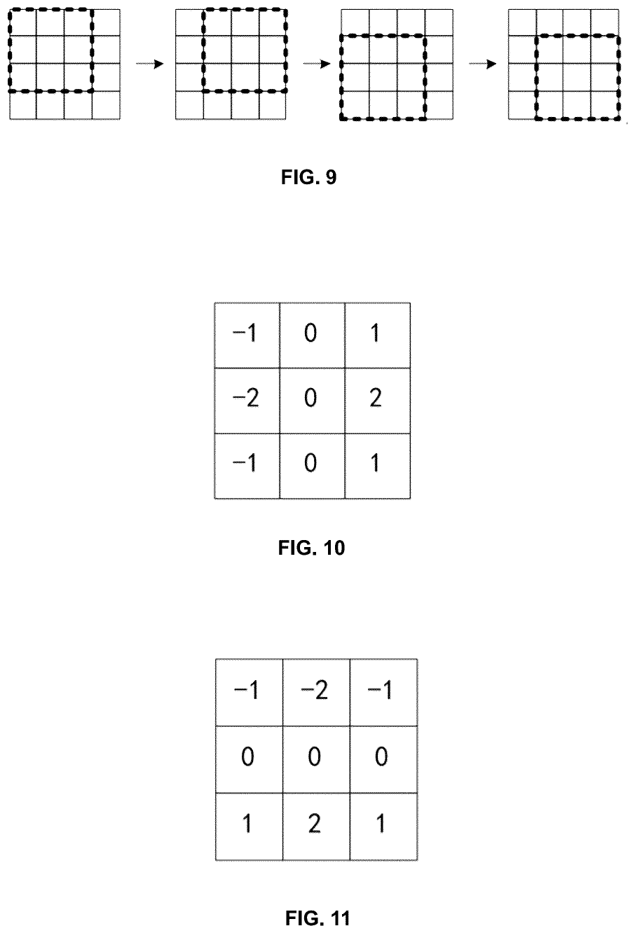

FIG. 9 is a schematic diagram illustrating an exemplary process for generating a plurality of windows on a current encoding block according to some embodiments of the present disclosure. In some embodiments, the processing device may generate the plurality of windows on the current encoding block according to a preset rule. For example, as shown in FIG. 9, the current encoding block may be moved and traversed in a raster scanning manner with a step size of 1 pixel on the current encoding block with a size of 4×4 by using a 3×3 window, four windows may be generated on the current encoding block, and the four windows are shown by dotted boxes in FIG. 9. In some embodiments, the processing device may also generate the plurality of windows in other ways, for example, the processing device may randomly generate the plurality of windows on the current encoding block.

In some embodiments, after generating the plurality of windows, the processing device may determine the texture direction of the current encoding block framed by each window, respectively. For example, the processing device may determine whether the texture direction of the current encoding block framed by each window is the horizontal direction or the vertical direction. Or, in another application scenario, the processing device may determine whether the texture direction of the current encoding block framed by each window is either horizontally, vertically, or neither horizontally nor vertically.

FIG. 10 is a schematic diagram of a horizontal direction of a Sobel operator according to some embodiments of the present disclosure. FIG. 11 is a schematic diagram of a vertical direction of a Sobel operator according to some embodiments of the present disclosure. For example, the processing device may calculate horizontal and vertical gradients of the current encoding block in each window by utilizing a Sobel operator. For example, for a window with a size of 3×3, the processing device may set the Sobel operator in the horizontal direction as shown in FIG. 10 and the Sobel operator in the vertical direction as shown in FIG. 11 (a size of horizontal and vertical directions of the Sobel operator may be the same as the size of the window), and for each window, a horizontal gradient value and a vertical gradient value of the current encoding block in the window may be determined by using the horizontal direction and the vertical direction of the Sobel operator. Ultimately, each window may include a horizontal gradient value and a vertical gradient value. For each window, if an absolute value of the corresponding horizontal gradient value is less than a horizontal threshold T0, the texture direction of the current encoding block in the window may be determined as the horizontal direction. If an absolute value of the corresponding vertical gradient value is less than a vertical threshold T1, the texture direction of the current encoding block in the window may be determined as the vertical direction. The horizontal threshold T0 and the vertical threshold T1 may be preset.

In some embodiments, after obtaining the texture direction corresponding to each window, the processing device may define the window corresponding to the horizontal direction of the texture direction as a first window and define the window corresponding to the vertical direction of the texture direction as a second window. The total count of windows, the count of first windows, the count of second windows, a first ratio of the count of first windows to the total count of windows, and a second ratio of the count of second windows to the total count of windows may be determined.

In some embodiments, if the first ratio is greater than or equal to a third threshold w₀, and the second ratio is less than a fourth threshold w₁, the processing device may determine that the texture direction of the current encoding block is the horizontal direction; if the first ratio is less than a fifth threshold w₂ and the second ratio is greater than or equal to a sixth threshold w₃, the processing device may determine that the texture direction of the current encoding block is the vertical direction. However, if none of the above conditions are met, the processing device may determine that the texture direction of the current encoding block is neither horizontal direction nor vertical direction. The third threshold w₀, the fourth threshold w₁, the fifth threshold w₂, and the sixth threshold w₃ may be predetermined.

In some embodiments, the processing device may also use other manners to determine the texture direction of the current encoding block. For example, the processing device may determine the texture direction of the current encoding block by using hash calculation.

In some embodiments, the texture direction of the current encoding block may be determined based on an original pixel value of each pixel in the current encoding block or based on an initial prediction value of each pixel in the current encoding block. More descriptions of the initial prediction value may be found in operation 440 and related descriptions. The determining the texture direction of the current encoding block based on the original pixel value of each pixel point in the current encoding block may include: substituting the original pixel value of each pixel point into various calculations, and obtaining the texture direction of the current encoding block; the determining the texture direction of the current encoding block based on the initial prediction value of each pixel in the current encoding block may include: substituting the initial prediction value of each pixel into various calculations to obtain the texture direction of the current encoding block.

In some embodiments, when determining the texture direction of the current encoding block based on the original pixel value of each pixel in the current encoding block, since the decoder may not know the original pixel value of each pixel in the current encoding block, the decoder does not know the current template used by the encoder when encoding. Therefore, in order to instruct the current template to the decoder, the encoder may add a syntactic element when transmitting the code stream to the decoder, the syntactic element may instruct the encoder to determine whether the current template region of the current encoding block is the first template region, the second template region, or the third template region during encoding. Specifically, the syntactic element may include a first identifier. When the current template region is the first template region, a value of the first identifier may be a first value; when the current template region is the second template region, a value of the first identifier may be a second value, when the current template region is the third template region, a value of the first identifier may be a third value, that is to say, the value of the first identifier may be related to a current template type.

In some embodiments, when determining the texture direction of the current encoding block based on the initial prediction value of each pixel in the current encoding block, since the decoder may know the initial prediction value of each pixel and the current template type used by the encoder during the encoding, the encoder may transmit the code stream without the need to transmit additional syntactic element. However, in order to reduce the computational complexity of the decoder, the encoder may also add a syntactic element when transmitting the code stream, the syntactic element may instruct the encoder to determine whether the current template region of the current encoding block is the first template region, the second template region, or the third template region during encoding.

In some embodiments, the processing device may also directly set the current template region of the current encoding block by adopting solutions in the prior art. That is to say, the processing device may directly set the current template region of the current encoding block as the first template region.

In some embodiments, the processing device may decode encoded data of the current template region, to obtain reconstruction data of the current template.

In 420, reference template reconstruction data may be obtained. The operation 420 may be performed by the second obtaining module 320.

The reference template reconstruction data may include reconstruction pixel data of a reference template region in a reference frame related to a reference encoding block.

The reference frame refers to an image frame in which the encoding block closest to the current encoding block is located among the coded image frames.

The reference encoding block refers to an encoding block closest to the current encoding block in the coded image frame.

The reference template region may include at least one reconstruction pixel around the reference encoding block. In some embodiments, the current template region may correspond to the reference template region.

A correspondence between the current template region and the reference template region refers to a distribution of the reconstruction pixels included in the current template region relative to the current encoding block, which may be the same as a distribution of the reconstruction pixels included in the reference template region relative to the reference encoding block. For example, when encoding each encoding block in the image frame in order from left to right and from top to bottom, if the reconstruction pixels included in the current template region are distributed on the left and upper sides of the current encoding block, the reconstruction pixels included in the reference template region may be distributed on the left side and the upper side of the reference encoding block. The count of reconstruction pixels included in the reference template region may be equal to the count of reconstruction pixels included in the current template region.

In some embodiments, after obtaining the current encoding block, the processing device may search an encoding block that matches the current encoding block in the reference frame, and designate the encoding block as a reference encoding block. For example, the processing device may determine an encoding block closest to the current encoding block in the reference frame through manners such as motion search.

In some embodiments, since the current template region corresponds to the reference template region, the processing device may determine the reference template region according to the current template region.

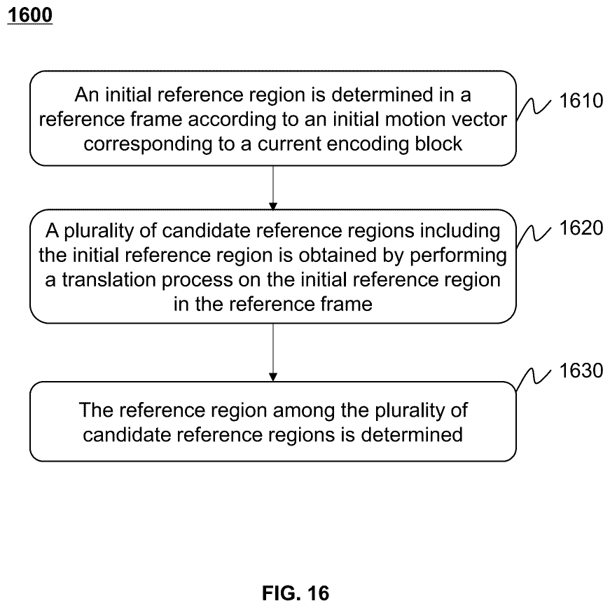

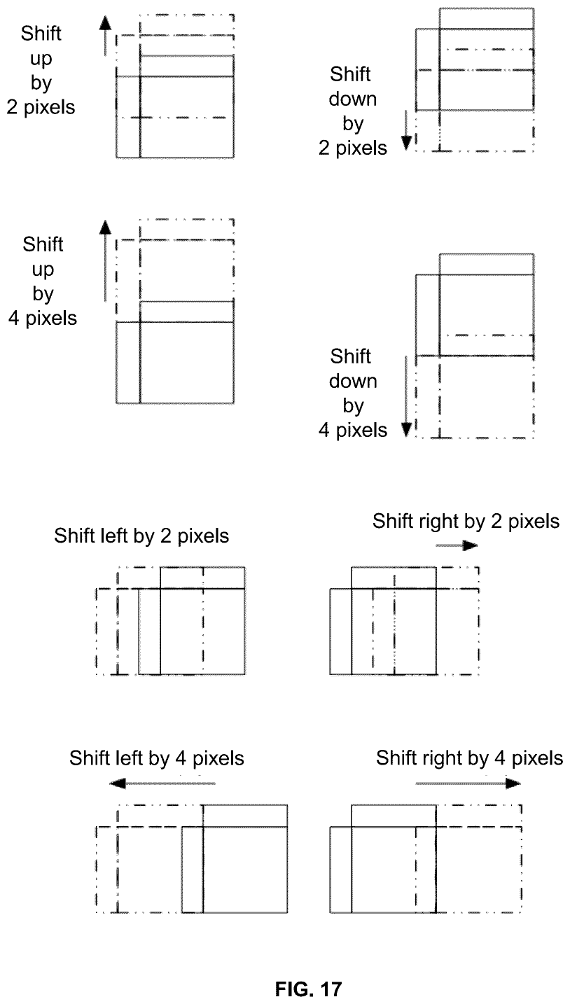

In some embodiments, the processing device may determine a reference region in the reference frame, the reference region may include a reference encoding block and/or a reference template region. Specifically, the processing device may determine an initial reference region in the reference frame according to an initial motion vector corresponding to the current encoding block. The processing device may perform a translation processing on the initial reference region in the reference frame to obtain a plurality of candidate reference regions including the initial reference region. The processing device may determine a reference region among the plurality of candidate reference regions. More descriptions of determining the reference region in the reference frame may be found in FIG. 16 and related descriptions.

In some embodiments, the processing device may decode the coded encoding data of the reference template region, to obtain reference template reconstruction data. In 430, a prediction value adjustment model of the current encoding block may be obtained based on the current template reconstruction data and the reference template reconstruction data. The operation 430 may be performed by the third obtaining module 330.

The prediction value adjustment model refers to a model that may adjust the initial prediction value to determine a target prediction value that is closer to the original pixel value of the current encoding block.

In some embodiments, the processing device may use a local illumination compensation (LIC) mode for encoding. That is to say, the processing device may use an illumination change between all pixels in the current template region of the current encoding block and all pixels in the reference template region of the reference encoding block to construct a linear model, which may represent a corresponding local illumination relationship between the current encoding block and the reference encoding block, parameters of the linear model may include a scaling factor α and an offset β, and the scaling factor and offset included in the prediction value adjustment model may be determined by a least square method. A difference in brightness between the current encoding block and the reference encoding block may be used, that is to say, a formula (1) may be used to determine a target prediction value of the pixel in the current encoding block:

$$qi = α \times pi + β , \qquad ( 1 )$$

where pi represents an initial prediction value of pixel i in the current encoding block, qi represents a target prediction value of pixel i, and the formula (1) may be a prediction value adjustment model.

In 440: an initial prediction value of the current encoding block may be obtained, and a target prediction value may be determined by adjusting the initial prediction value according to the prediction value adjustment model. The operation 440 may be performed by the first determination module 340.

The initial prediction value refers to a value obtained after initial prediction of the current encoding block. Each pixel in the current encoding block may be a current encoding pixel, and each current encoding pixel may correspond to the initial prediction value. The initial prediction values of different currently encoded pixels may be the same or different.

In some embodiments, the processing device may perform motion compensation according to a motion vector (MV) of the current encoding block and the reference encoding block to obtain the initial prediction value. Merely for example, the processing device may obtain the initial prediction value of the current encoding block through the following manner:

Step 1: a reference block (i.e., the reference encoding block) corresponding to the current block (i.e., the current encoding block) in the reference frame may be found. For example, if a coordinate of the current block is (2, 3), the position (2, 3) may be found in the reference frame to be designated as a position of the reference frame corresponding to the current block. According to the MV, assuming that MV is (−1,−1), the position (2, 3) of the reference frame may be offset to an upper left corner (−1,−1), and the position after the offset may be a position of the reference block corresponding to the current block in the reference frame.

Step 2: an initial prediction value of the current block may be obtained directly according to the reconstruction pixel value of the reference block. That is to say, the reconstruction pixel value of the reference block may be designated as the initial prediction value of the current block.

The processing device may obtain the initial prediction value through other existing encoding manners.

The target prediction value refers to a final obtained prediction value that is closer to the original pixel value of the current encoding block.

In some embodiments, the processing device may sequentially input the initial prediction value of each pixel in the current encoding block into the prediction value adjustment model of the formula (1) to output a target prediction value of each pixel in the current encoding block, so that the target prediction value of the current encoding block may be determined.

In 450, based on the target prediction value, the encoding data of the current encoding block may be determined. The operation 450 may be performed by the second determination module 350.

The encoding data of the current encoding block refers to data obtained after encoding the current encoding block.

In some embodiments, the processing device may determine a residual based on a difference between the target prediction value and the original pixel value. Then, the processing device may determine the encoding data of the current encoding block by encoding the adopted prediction mode and the residual calculated when the prediction mode is adopted.

In some embodiments of this specification, the target prediction value may be determined by obtaining the prediction value adjustment model of the current encoding block, so that the encoder may encode the adopted prediction mode and the residual calculated when the prediction mode is adopted, the decoder may decode a corresponding pixel value according to information of the code stream, which can greatly reduce code words required for encoding. At the same time, in the prediction mode, when obtaining the current template region, considering characteristics of the current encoding block, a more accurate target prediction value of each encoding block and the target prediction value of each encoding block may be obtained during decoding. A more accurate restored pixel value may be obtained for each encoding block during decoding, which can improve the effect of encoding and decoding, and reduce the losses caused by video encoding and decoding.

It should be noted that the above description of the process 400 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

In some embodiments, the processing device may determine the target prediction value through other manners.

In some embodiments, the processing device may sequentially use the current template of the current encoding block as the first template region, the second template region, and the third template region to determine a candidate target prediction value of the current encoding pixel; each pixel in the current encoding block may be designated as the current encoding pixel sequentially, and the candidate target prediction value of each pixel in the current encoding block under the first template region, the second template region, and the third template region, the candidate target prediction values of all pixels in the current encoding block may be obtained. The processing device may determine cost values corresponding to the first template region, the second template region, and the third template region according to the candidate target prediction values of all pixels in the current encoding block under the first template region, the second template region, and the third template region, respectively. In response to a minimum cost value corresponding to the first template region, the candidate target prediction value of each pixel under the first template region may be determined as the target prediction value of each pixel; in response to the minimum cost value corresponding to the second template region, the candidate target prediction value of each pixel under the second template region may be determined as the target prediction value of each pixel. In response to the minimum cost value corresponding to the third template region, the candidate target predictive value of each pixel under the third template region may be determined as the target predictive value of each pixel. More descriptions of the first template region, the second template region, and the third template region may be found in the operation 410 and related descriptions.

The current template pixel in the first template region may be distributed on a first side and a second side of the current encoding block. The current template pixel in the second template region may be distributed on the first side of the current encoding block; the current template pixel in the third template region may be distributed on the second side of the current encoding block.

In some embodiments, the processing device may designate each pixel in the current encoding block as the current pixel sequentially, and after performing the foregoing operations, for each pixel in the current encoding block, the target prediction value under the first template region, the target prediction value under the second template region, and the target prediction value under the third template region may be obtained.

In some embodiments, for the first template region, the processing device may determine the cost value corresponding to the first template region according to the target prediction values of all pixels in the current encoding block under the first template region; for the second template region, the processing device may determine the cost value corresponding to the second template region according to target prediction values of all pixels in the current encoding block under the second template region. For the third template region, the processing device may determine the cost value corresponding to the third template region according to target prediction values of all pixels in the current encoding block under the third template region.

The cost value is a rate-distortion cost value, and the cost value represents an accuracy rate of the candidate target prediction value of each pixel in the first template region, the second template region, and the third template region as a final prediction value. The less the cost value, the higher the accuracy rate. The processing device may determine the cost values corresponding to the first template region, the second template region, and the third template region based on a cost function. The cost function may include a sum of squared difference (SSD), a sum of absolute difference (SAD), a sum of absolute transformed difference (SATD), or the like.

In some embodiments, if the cost value corresponding to the first template region is the smallest among the first template region, the second template region, and the third template region, the first template region has a greater influence on the current encoding block than the second template region and the third template region, and the candidate target prediction value of each pixel under the first template region may be determined as the target prediction value for each pixel, respectively.

In some embodiments, if the cost value corresponding to the second template region is the smallest among the first template region, the second template region, and the third template region, the second template region has a greater influence on the current encoding block than the first template region and the third template region, and the candidate target prediction value of each pixel under the second template region may be determined as the target prediction value for each pixel, respectively.

In some embodiments, if the cost value corresponding to the third template region is the smallest among the first template region, the second template region, and the third template region, the third template region has a greater influence on the current encoding block than the first template region and the second template region, and the candidate target prediction value of each pixel under the third template region may be determined as the target prediction value for each pixel, respectively.

In sone embodiment, after obtaining the cost value corresponding to the first template region, the cost value corresponding to the first template region may be recorded as RDcost1. After obtaining the cost value corresponding to the second template region, the cost value corresponding to the second template region may be recorded as RDcost2. After obtaining the cost value corresponding to the third template region, the cost value corresponding to the third template region may be recorded as RDcost3, and the sizes of RDcost1, RDcost2, and RDcost3 may be compared. If RDcost1 is the smallest, the current template of the current encoding block may be set as the first template region.

In some embodiments of the present disclosure, the candidate target prediction value of each pixel point in the region with the least cost among the first template region, the second template region, and the third template region may be determined as the target prediction value of each pixel, so that the target prediction value of any pixel in the current encoding block may be a prediction value of the pixel under a template that has the greatest influence on the current encoding block.

In some embodiments, in order to instruct the current template of the current encoding block to the decoder, the encoder may add the syntactic element when transmitting the code stream, and the syntactic element may instruct the encoder to set the current template of the current encoding block as the first template region, the second template region, or the third template region during encoding. For example, in the syntactic element, the processing device may set a block-level syntactic identifier lic_sub_mode. When lic_sub_mode is equal to 0, it may indicate that the current template of the current encoding block is the first template region; when lic_sub_mode is equal to 1, it may indicate that the current template of the current encoding block is the second template region, and when lic_sub_mode is equal to 2, it may indicate that the current template of the current encoding block is the third template region. That is to say, a fourth syntactic element may include a first identifier. When the cost value corresponding to the first template region is the smallest among the cost values corresponding to the first template region, the second template region, and the third template region, a value of the first identifier may be a first value; when the cost value corresponding to the second template region is the smallest among the cost values corresponding to the first template region, the second template region, and the third template region, the value of the second identification is the second value. When the cost value corresponding to the third template region is the smallest among the cost values corresponding to the first template region, the second template region, and the third template region, a value of the first identifier is third data.

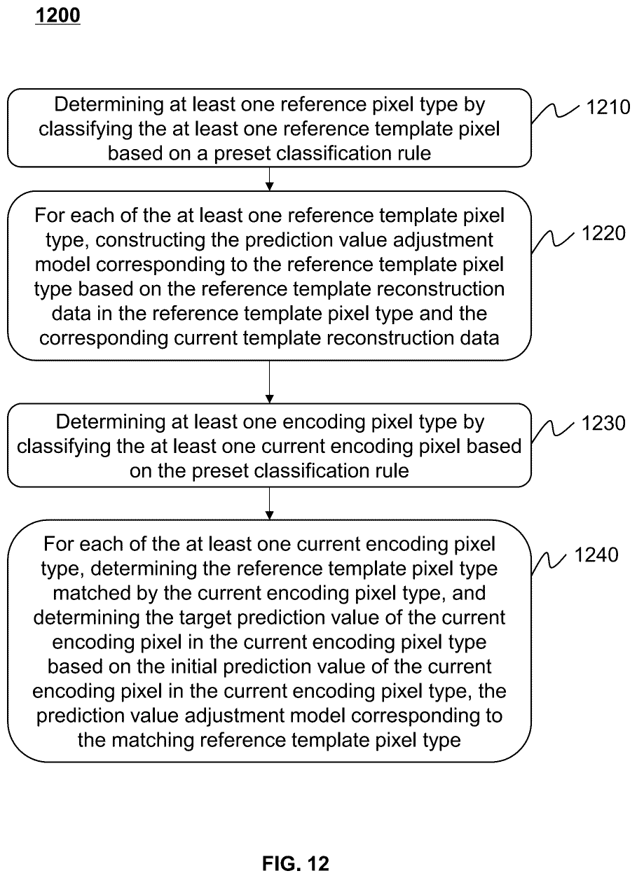

In some embodiments, the processing device may classify at least one reference template pixel based on a preset classification rule and determine at least one reference template pixel type; for each of the at least one reference template pixel type, based on the reference template reconstruction data in the reference template pixel type and the corresponding current template reconstruction data, a prediction value adjustment model corresponding to the reference template pixel type may be constructed. The processing device may classify at least one current encoding pixel based on the preset classification rule and determine at least one current encoding pixel type; for each of at least one current encoding pixel type, a reference template pixel type that matches the current encoding pixel type may be determined and a target prediction value of the current encoding pixel in the current pixel type may be determined based on the initial prediction value of the current encoding pixel in the current encoding pixel type and the prediction value adjustment model corresponding to the matching reference template pixel type. More descriptions of the above manner may be found in FIG. 12 and related descriptions.

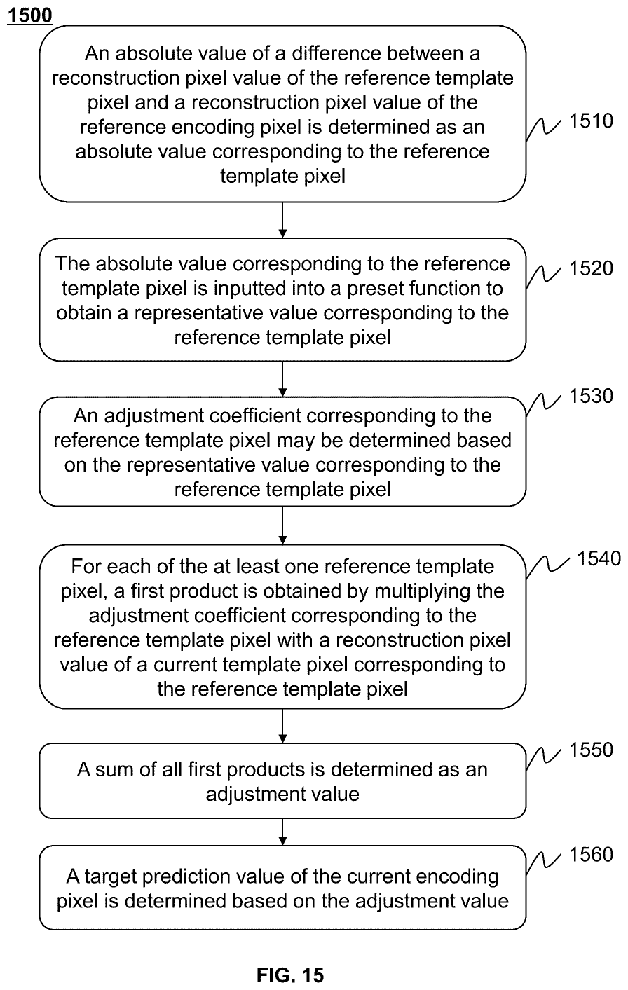

In some embodiments, in response to the current encoding block include a plurality of current encoding pixels, for each of the plurality of current encoding pixels, the processing device may obtain, based on a reconstruction pixel value, reference template reconstruction data, and current template reconstruction data of a reference encoding pixel corresponding to the current encoding pixel in the reference encoding block, a prediction value adjustment model of the current encoding pixel; and the processing device may determine a target prediction value of the current encoding pixel by adjusting, based on an initial prediction value of the current encoding pixel, the initial prediction value of the current encoding pixel according to the prediction value adjustment model of the current encoding pixel. More descriptions of the above manners may be found in FIG. 15 and related descriptions.

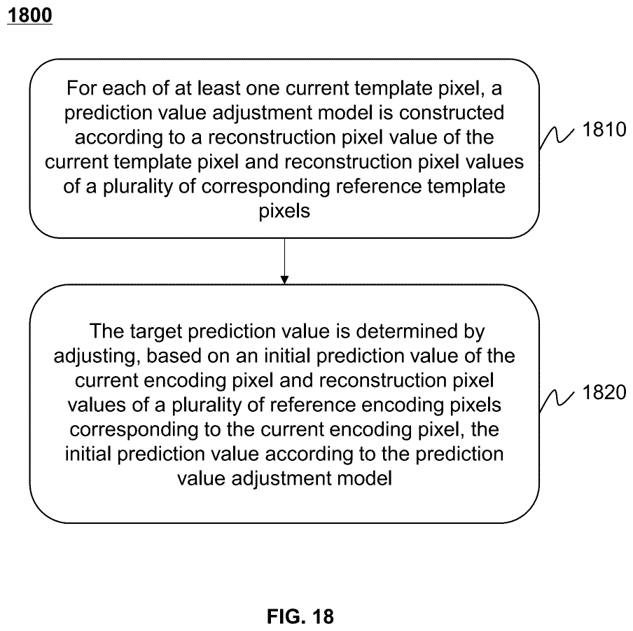

In some embodiments, for each of at least one current template pixel, the processing device may construct a prediction value adjustment model according to the reconstruction pixel of the current template pixel and the reconstruction pixels of corresponding multiple reference template pixels, and based on the initial prediction value of the current encoding pixel, the reconstruction pixel values of the multiple reference encoding pixels corresponding to the current encoding pixel, and the initial predicted value may be adjusted through the predicted value adjustment model to determine the target prediction value. More descriptions of the above manners may be found in FIG. 18 and related descriptions.

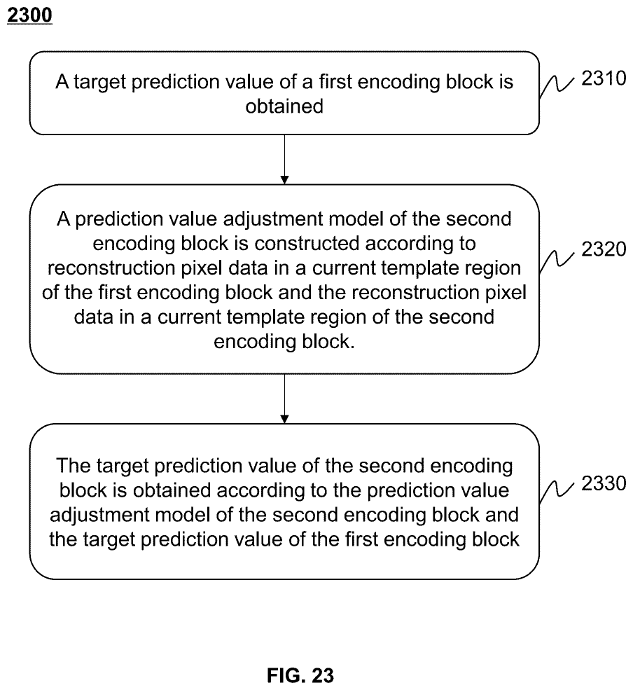

In some embodiments, the current encoding block may include a first encoding block and a second encoding block, the first encoding block may be a first color component block and the second encoding block may be a second color component block. In some embodiments, the processing device may obtain a target prediction value of the first encoding block; and construct a prediction value adjustment model of the second encoding block based on the reconstruction pixel data of the current template region of the first encoding block and reconstruction pixel data in a current template region of the second encoding block; and the processing device may further obtain a target prediction value of the second encoding block based on a prediction value adjustment model of the second encoding block and a target prediction value of the first encoding block. In some embodiments, the processing device may obtain a target prediction value of the first encoding block, construct a prediction value adjustment model of the second encoding block based on a reconstructed pixel value of a reference encoding block of the first encoding block, and a target prediction value of the first encoding block, and obtain a target prediction value of the second encoding block based on a prediction value adjustment model of the second encoding block and a reconstruction pixel value of a reference encoding block of the second encoding block. In some embodiments, the processing device may obtain a target prediction value of the first encoding block, obtain a reconstruction pixel value of the first encoding block, construct a prediction value adjustment model of the second encoding block based on reconstruction pixel data of a reference encoding block of the first encoding block and reconstruction pixel data of a reference encoding block of the second encoding block, and obtain a target prediction value of the second encoding block based on a prediction value adjustment model of the second encoding block, a target prediction value of the first encoding block. More descriptions of the above manners may be found in FIGS. 23-28 and the related descriptions.

FIG. 12 is a flowchart illustrating an exemplary process for determining a target prediction value of a current encoding pixel in a current encoding pixel type according to some embodiments of the present disclosure. In some embodiments, process 1200 may be executed by the determining a target prediction value of a current encoding pixel in a current encoding pixel type system 100. For example, the process 1200 may be implemented as a set of instructions stored in a storage device. In some embodiments, the processing device 140 (e.g., the processor 210 of the computing device 200 and/or one or more modules illustrated in FIG. 3) may execute the set of instructions and may accordingly be directed to perform the process 1200. The operations of the illustrated process presented below are intended to be illustrative. In some embodiments, the process 1200 may be accomplished with one or more additional operations not described and/or without one or more of the operations discussed. Additionally, the order of the operations of process 1200 illustrated in FIG. 12 and described below is not intended to be limiting.

In an existing encoding process using the LIC mode, in the current encoding block, the α corresponding to all pixels may be the same, and the β corresponding to all pixels may be also the same, that is to say, when a linear model compensates for illumination of different pixels in the same encoding block, the compensation may be performed according to the same standard. However, in fact, an illumination change relationship between different pixels and the reference encoding block is not exactly the same, the existing encoding process does not match the implementation. In order to overcome the defects in the prior art, in some embodiments, the reference template reconstruction data may include at least one reconstruction pixel value of the reference template pixel, the current template reconstruction data may include at least one reconstruction pixel value of the current template pixel, and the initial prediction value of the current encoding block may include at least one initial prediction value of the current encoding pixel.

In 1210, at least one reference template pixel type may be determined by classifying the at least one reference template pixel may be classified based on a preset classification rule.

The preset rule refers to a rule that pre-set.

The reference template pixel type refers to a reference template pixel set obtained after classifying the at least one reference template pixel. The two reference template pixels whose reconstruction pixel values are relatively close to the reference template pixel may be classified into a same reference template pixel type, and the two reference template pixels whose reconstruction pixel values may be relatively different may be classified into different reference template pixel types.

In some embodiments, the processing device may determine at least one pixel threshold corresponding to the current encoding block, and generate at least one classification interval according to the at least one pixel threshold. For each classification interval, the processing device may add the reference template pixel whose the reconstruction pixel value of the reference template pixel that is in the classification interval to the reference template pixel type corresponding to the classification interval.

The pixel threshold refers to a boundary value of the classification interval. In some embodiments, there may be one or more pixel thresholds corresponding to the current encoding block. When the count of the pixel threshold is n, the count of the classification interval may be n+1.

In some embodiments, the pixel threshold corresponding to the current encoding block may be a fixed threshold preset and stored in the storage device. The processing device may obtain at least one pre-stored pixel threshold corresponding to the current encoding block directly from the data stored in the storage device.

In some embodiments, the pixel threshold value corresponding to the current encoding block may be related to the reconstruction pixel value of the reference template pixel in the reference template. In some embodiments, the processing device may obtain a sum of reconstruction pixel values of all reference template pixels in the reference template. The processing device may determine at least one pixel threshold based on the sum of the reconstruction pixel values of the reference template pixels and the count of pixel thresholds.

For example, the processing device may sum the reconstruction pixel values of the reference template pixels of all the reference template pixels in the reference template to obtain the sum of the reconstruction pixel values of the reference template pixels, which may be recorded as m. The processing device may record the count of pixel thresholds corresponding to the current encoding block as n (where n represents the count of pixel thresholds between 0 and m), the at least one pixel threshold may be respectively: m/(n+1), 2m/(n+1), . . . , and nxm/(n+1). When the determined pixel threshold has a fractional portion, the pixel threshold may be rounded downward or upward, or may not be rounded. For example, assuming that the sum of the reconstruction pixel values of the reference template pixels of all the reference template pixels in the reference template is determined as 6000 after calculation, and the count of pixel thresholds is 4, the four pixel value thresholds between 0 and m corresponding to the current encoding block are: 1200, 2400, 3600, and 4800.

In some embodiments, the processing device may also determine the at least one pixel threshold corresponding to the current encoding block by using other manners.

The count of pixel thresholds corresponding to the current encoding block may be positively correlated with a size of the current encoding block. The size of the current encoding block refers to a product of the width and the height of the current encoding block. The positive correlation refers to that the larger the size of the current encoding block, the more the count of pixel thresholds corresponding to the current encoding block, or as the size of the current encoding block becomes larger, the overall count of pixel thresholds corresponding to the current encoding block also increases. However, there is also a phenomenon that in some stages, as the size of the current encoding block increases, the count of pixel thresholds corresponding to the current encoding block remains unchanged or even decreases.

The larger the size of the current encoding block, the greater the count of reference template pixels in the reference template region, the wider the distribution of the reconstruction pixel values of the reference template pixels, and the count of pixel thresholds may be positively correlated with the size of the current encoding block, making the reconstruction pixel values of the reference template pixels in the reference template pixel type closer to each other, and ensuring a closer connection between the reference template pixels in the reference template pixel type.

In some embodiments, the count of pixel thresholds corresponding to the current encoding block may also be independent of the size of the current encoding block, for example, regardless of the size of the current encoding block, the count of pixel thresholds corresponding to the current encoding block is N, N may include 1, 3, 5 and other positive integers.

In some embodiments, after determining the at least one pixel threshold corresponding to the current encoding block, the processing device may generate the plurality of classification intervals according to the at least one pixel threshold. For example, assuming that there are three pixel thresholds, and the three pixel thresholds may be A1, A2, and A3, four classification intervals including (−∞, A1), [A1, A2), [A2, A3), and [A3, +∞) may be constructed. Assuming that only one pixel threshold is included, and the pixel threshold may be B1, two classification intervals including (−∞, B1) and [B1, +∞) may be constructed.

In some embodiments, after constructing the classification interval, the processing device may classify the reference template pixels whose reconstruction pixel values of the reference template pixels are in a same classification interval into a pixel type to classify the reference template pixels.

In some embodiments, the processing device may classify, based on a clustering algorithm, reference template pixels based on the reconstruction pixel values of the reference template pixels to obtain at least one reference template pixel type.

The clustering algorithm may include a k-means clustering algorithm, a DBSCAN clustering algorithm, a CLARANS clustering algorithm, or the like.

In some embodiments, the processing device may preset several clustering centers, and add at least one reference template pixel in the reconstruction pixel value of the reference template pixel that has a difference less than a preset value from a clustering center pixel value to a corresponding pixel type of the clustering center, thereby forming a pixel type corresponding to the cluster center and obtaining a plurality of reference template pixel types.

After classifying the reference template pixels by using the clustering algorithm, escaped pixels may exist, that is, the escaped pixel may be quite different from each reference template pixel type and cannot be classified into any reference template pixel by the clustering algorithm. For illustration conveniently, the escape pixels may be defined as a first escape pixel.

In some embodiments, the processing device may force the first escape pixel to be classified, that is to say, after classifying the reference template pixels by using the using a clustering algorithm, in response to the presence of the first escape pixel in the reference template that does not belong to any of the reference template pixel types, each first escape pixel may be added to the reference template pixel type with the smallest difference from each other.

In some embodiments, the processing device may forcibly classify the first escape pixel, that is to say, after classifying the reference template pixels by using the clustering algorithm, in response to the presence of the first escape pixel in the reference template that does not belong to any of the reference template pixel types, each first escape pixel may be added to the reference template pixel type with the smallest difference from each other. The reference template pixel type with the smallest difference from the first escaped pixel refers to the reference template pixel type corresponding to the clustering center with the smallest pixel difference from the reconstruction pixel value of the first escaped pixel.

In some embodiments, the processing device may determine an average value of the reconstruction pixel values of the reference template pixels and classify the reference template pixels into two reference template pixel types according to the average value. The reference template pixel type may include reference template pixels whose reconstruction pixel values do not exceed the average value, and the other reference template pixel types may include reference template pixels whose reconstruction pixel values exceed the average value.

In 1220, for each of at least one reference template pixel type, based on the reference template reconstruction data in the reference template pixel type and the relevant current template reconstruction data, a corresponding prediction value adjustment model of the reference template pixel type may be constructed.

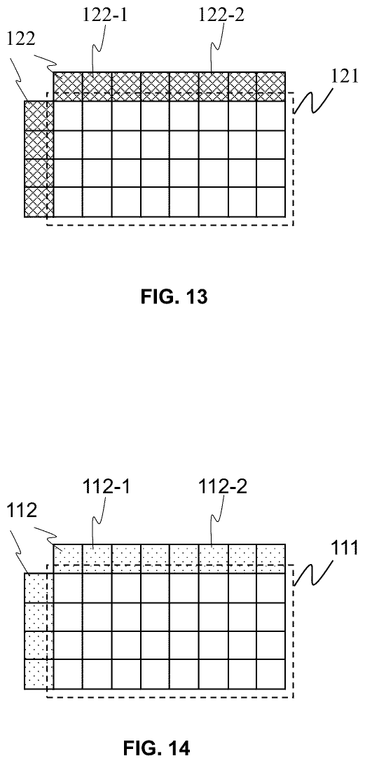

FIG. 13 is a schematic diagram illustrating an exemplary reference encoding block and reference template region according to some embodiments of the present disclosure. FIG. 14 is a schematic diagram illustrating an exemplary current encoding block and current template region according to some embodiments of the present disclosure. The associated current template reconstruction data refers to the reconstruction pixel value of the current template pixel at a same location as the reference template pixel. For example, as shown in FIG. 13 and FIG. 14, the pixels filled with grids around the reference encoding block 121 in FIG. 13 may be a reference template region 122 in the reference template, and the pixels filled with dots around the current encoding block 111 in FIG. 14 may be a current template region 112. The reconstruction pixel value of the current template pixel related to the reconstruction pixel value of the reference template pixel 122-1 in FIG. 13 may be the reconstruction pixel value of the current template pixel 112-1 in FIG. 14, and the reconstruction pixel value of the current template pixel related to the reconstruction pixel value of the reference template pixel 122-2 in FIG. 13 may be the reconstruction pixel value of the current template pixel 112-2 in FIG. 14.

In some embodiments, the processing device may construct a linear model by using the illumination change between the reference template pixel in the reference template pixel type and the pixel in the current template at the same position as the reference template pixel, that is the prediction value adjustment model corresponding to the reference template pixel type. The process of constructing the prediction value adjustment model corresponding to the reference template pixel type may be similar to the process of obtaining the prediction value adjustment model of the current encoding block in the operation 430, which may not be repeated here. Understandably, each reference template pixel type may correspond to a prediction value adjustment model.

In 1230, at least one current encoding pixel type may be determined by classifying the at least one current encoding pixel based on a preset classification rule.

The rule for classifying the reference template pixel may be the same as the rule for classifying the current encoding pixel. That is to say, when classifying the reference template pixels, the standard for classifying two reference template pixels into the same reference template pixel type may be the same as the standard for classifying two current encoding pixels into the same current code type when classifying the current encoding pixels.

In some embodiments, for each classification interval, the processing device may add the current encoding pixel whose the initial prediction value is in the classification interval to the current encoding pixel type corresponding to the classification interval.

In some embodiments, the processing device may obtain at least one current encoding pixel type by classifying, by using the clustering algorithm, the current encoding pixels based on the initial prediction values of the current encoding pixels.

Similarly, after classifying the current encoding pixels by using the clustering algorithm, escape pixels may exist, and the escape pixel may be defined as a second escape pixel. The processing device may forcibly classify the second escape pixel point, that is to say, in response to the presence of second escape pixel in the current encoding block that does not belong to any of current template pixel types, each second escaped pixel may be added to the current template pixel type with a smallest difference, respectively. It should be noted that when forcibly classifying the first escape pixel, in order to ensure that the rule for classifying the reference template pixel is the same as the rule for classifying the current coded pixel, the second escape pixel may also be forcibly classified class, and the process of forcibly classifying the second escaped pixel may be the same as the process of forcibly classifying the first escaped pixel.

In some embodiments, the processing device may determine an average value of the initial prediction values of the current encoding pixel, and classify the current encoding pixel according to the average value to obtain two current encoding pixel types. One of the current encoding pixel types may include a current encoding pixel whose initial prediction value does not exceed the average value, and another current encoding pixel type may include the current encoding pixel whose initial prediction value exceeds the average value.

The above-mentioned process of determining the at least one current encoding pixel type is similar to the process of determining the at least one reference template pixel type in the operation 1210, which may not be repeated here.

It should be understood that, since the rule for classifying the reference template pixel is the same as the rule for classifying the current encoding pixel, a certain reference template pixel type may be the same as a certain current encoding pixel type, that is to say, a distribution range of the reconstruction pixel values of the reference template pixels included in the certain reference template pixel type may be the same or approximately the same as a distribution range of the initial prediction values of the current encoding pixels included in the certain current encoding pixel type. After classifying the at least one current encoding pixel, the two current encoding pixels whose initial prediction values are relatively close may be classified into the same current encoding pixel type, while the two current encoding pixels with significantly different initial prediction values are usually classified into different current encoding pixel types.

In 1240, for each of the at least one current encoding pixel type, the reference template pixel type matched by the current encoding pixel type may be determined, and the target prediction value of the current encoding pixel in the current encoding pixel type may be determined based on the initial prediction value of the current encoding pixel in the current encoding pixel type, the prediction value adjustment model corresponding to the matching reference template pixel type.

In some embodiments, the processing device may determine the current encoding pixel type with a same type as the reference template pixel type, and input the initial prediction value of each current encoding pixel in each current encoding pixel type into the prediction value adjustment model corresponding to the matching reference template pixel type. More descriptions of determining the target prediction value may be found in FIG. 4 and the related descriptions.

When determining the current encoding pixel type with a same type as a current encoding pixel type, if a reference template pixel type with a same type as the current encoding pixel type cannot be found, the current encoding pixel type may not be predicted subsequently. For each current encoding pixel in the current encoding pixel type, the initial prediction value of each current encoding pixel may be determined as the corresponding target predicted value directly.

In some embodiments of the present disclosure, for any current encoding pixel type, the matching target prediction value adjustment model can accurately reflect an illumination relationship between the current encoding pixel in the current encoding pixel type and the corresponding pixel in the reference encoding block. Therefore, predicting each current encoding pixel in the current encoding pixel type by using the prediction value adjustment model respectively can ensure the accuracy of prediction of the current encoding pixel and achieve the purpose of optimizing the visual effect of the image finally.

It should be noted that the above description of the process 400 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

In some embodiments, in response to the presence of the second escape pixel in the current encoding block that does not belong to any of the current template pixel types, the processing device may determine the initial prediction value of each second escape pixel as a target prediction value of the second escape pixel instead of classify the current encoding pixel.

FIG. 15 is a flowchart illustrating an exemplary process for determining a target prediction value of a current encoding pixel according to some embodiments of the present disclosure. In some embodiments, a process 1500 may be executed by the system 100 for determining the target prediction value of the current encoding pixel. For example, the process 1500 may be implemented as a set of instructions stored in a storage device. In some embodiments, the processing device 140 (e.g., the processor 210 of the computing device 200 and/or one or more modules illustrated in FIG. 3) may execute the set of instructions and may accordingly be directed to perform the process 1500. The operations of the illustrated process presented below are intended to be illustrative. In some embodiments, the process 1500 may be accomplished with one or more additional operations not described and/or without one or more of the operations discussed. Additionally, the order of the operations of the process 1500 illustrated in FIG. 15 and described below is not intended to be limiting.

In 1510, an absolute value of a difference between a reconstruction pixel value of the reference template pixel and a reconstruction pixel value of the reference encoding pixel is determined as an absolute value corresponding to the reference template pixel.

Assuming that a count of reference template pixels in a reference template region is k, the processing device may determine a difference between the reconstruction pixel value of the reference coded pixel and a reconstruction pixel value of k reference template pixels respectively, and take an absolute value of a result of the difference. Then k absolute values are obtained, and the k absolute values are denoted as D₀, D₁, D₂, . . . , and Dₖ₋₁, respectively.

In 1520, the absolute value corresponding to the reference template pixel is inputted into a preset function to obtain a representative value corresponding to the reference template pixel.

The preset function may be a function preset before. In some embodiments, the preset function may be a linear function or a non-linear function. The preset function may satisfy a condition that the representative value corresponding to the reference template pixel and the absolute value corresponding to the reference template pixel are positively correlated.

In some embodiments, the processing device may automatically generate a preset function that satisfies the condition.

In some embodiments, the representative value corresponding to the reference template pixel and the absolute value corresponding to the reference template pixel are positively correlated. That is, the greater the absolute value corresponding to the reference template pixel is, the greater the representative value corresponding to the reference template pixel is. As the absolute value corresponding to the reference template pixel increases, the representative value corresponding to the reference template pixel also increases overall. But there may also be a case when an absolute value corresponding to a reference template pixel p is greater than an absolute value corresponding to a reference template pixel q, a representative value corresponding to the reference template pixel p is equal to a representative value corresponding to the reference template pixel q.

In some embodiments, the processing device may input the absolute value corresponding to the reference template pixel into the preset function, to obtain the representative value corresponding to the reference template pixel. That is, the processing device may input the absolute values D₀, D₁, D₂, . . . , and Dₖ₋₁ into the preset function respectively, and representative values obtained are denoted as V₀, V₁, V₂, . . . , and Vₖ₋₁, wherein, S₀, S₁, S₂, . . . and Sₖ₋₁ are in one-to-one correspondence with D₀. D₁, D₂ . . . , and Dₖ₋₁.

In 1530, an adjustment coefficient corresponding to the reference template pixel may be determined based on the representative value corresponding to the reference template pixel.

In some embodiments, parameters of the prediction value adjustment model may include the at least one adjustment coefficient, and the at least one adjustment coefficient is in one-to-one correspondence with the at least one reference template pixel in the reference template. The adjustment coefficient corresponding to the reference template pixel and a reconstruction pixel gap corresponding to the reference template pixel are positively correlated. The reconstruction pixel gap corresponding to the reference template pixel is a gap between the reconstruction pixel value of the reference template pixel and a reconstruction pixel value of the reference encoded pixel. It can be understood that the greater the reconstruction pixel gap corresponding to the reference template pixel is, the greater the gap between the reconstruction pixel value of the reference template pixel and the reconstruction pixel value of the reference encoded pixel.

For example, assuming that the count of reference template pixels in the reference template region is k, then the prediction value adjustment model includes k adjustment coefficients, and each reference template pixel corresponds to an adjustment coefficient, and the adjustment coefficient corresponding to the reference template pixel and the reference reconstruction pixel value corresponding to the template pixels are positively correlated. That is, the greater the reconstruction pixel gap corresponding to the reference template pixel, the greater the adjustment coefficient corresponding to the reference template pixel. As the reconstruction pixel gap corresponding to the reference template pixel increases, the adjustment coefficient corresponding to the reference template pixel also increases overall. But there may also be a case when a reconstruction pixel gap corresponding to the reference template pixel p is greater than a reconstruction pixel gap corresponding to the reference template pixel q, an adjustment coefficient corresponding to the reference template pixel p is equal to an adjustment coefficient corresponding to the reference template pixel q.

In some embodiments, the processing device may obtain a first sum value by summing representative values corresponding to all the reference template pixels, and determine a ratio of the representative value corresponding to the reference template pixel to the first sum value as the adjustment coefficient corresponding to the reference template pixel. For example, the processing device may add the representative values V₀, V₁, V₂, . . . , and Vₖ₋₁ to obtain the first sum value, and determine adjustment coefficients S₀, S₁, S₂, . . . , and Sₖ₋₁ corresponding to the k reference template pixels based on an equation: Sn=Vn/(V₀+V₁+V₂+ . . . +Vₖ₋₁), n=0, 1, . . . , k−1, where, S₀, S₁, S₂, . . . and Sₖ₋₁ are in one-to-one correspondence with D₀. D₁, D₂ . . . , and Dₖ₋₁.

In some embodiments, the processing device may directly use the representative value corresponding to the reference template pixel as the adjustment coefficient corresponding to the reference template pixel.

By adjusting the preset function according to an actual need, a gap between representative values corresponding to two reference template pixels may be less than a gap between absolute values corresponding to two reference template pixels, or the gap between the representative values corresponding to the two reference template pixels may be greater than the gap between the absolute values corresponding to the two reference template pixels, so that a scheme is flexible and meets various practical needs.

In some embodiments, the processing device may not input an absolute value corresponding to each reference template pixel into the preset function, but directly determine the adjustment coefficient of the reference template pixel according to the absolute value corresponding to the reference template pixel. For example, the processing device may determine the adjustment coefficients S₀, S₁, S₂ . . . , and Sₖ₋₁ corresponding to the k reference template pixels based on an equation Sn=Dₙ/(D₀+D₁+D₂+ . . . +Dₖ₋₁), n=0, 1 . . . , k−1, where S₀, S₁, S₂, . . . and Sₖ₋₁ are in one-to-one correspondence to D₀, D₁, D₂ . . . , Dₖ₋₁.

In 1540, for each of the at least one reference template pixel, a first product is obtained by multiplying the adjustment coefficient corresponding to the reference template pixel with a reconstruction pixel value of a current template pixel corresponding to the reference template pixel.

Taking the count of reference template pixels in the reference template region being k as an example, the processing device may record reconstruction pixel values of current template pixels corresponding to the k reference template pixels as m₀, m₁, m₂, . . . , and mₖ₋₁, where S₀ and m₀ correspond to a same reference template pixel, S₁ and m₁ correspond to a same reference template pixel, . . . , and Sₖ₋₁ and mₖ₋₁ correspond to a same reference template pixel. Next, the processing device may obtain a first product of the k reference template pixels by calculating a product of S₀ and m₀, a product of S₁ and m₁, . . . , and a product of Sₖ₋₁ and mₖ₋₁.

In 1550, a sum of all first products is determined as an adjustment value.

Taking the count of reference template pixels in the reference template region being k as an example, the processing device may determine an adjustment value A based on an equation A=S₀×m₀+S₁×m₁+S₂×m₂+ . . . +Sₖ₋₁×mₖ₋₁.

In 1560, a target prediction value of the current encoding pixel is determined based on the adjustment value.

In some embodiments, the processing device may obtain the target prediction value of the current encoding pixel based on an initial prediction value of and an adjustment value of the current encoding pixel. The initial prediction value of the current encoding pixel is obtained based on motion information between a current encoding block and a reference encoding block. For more content on determining the initial prediction value, please refer to FIG. 4 and its related descriptions. For example, the processing device may perform an averaging processing on the initial prediction value and the adjustment value of the current encoding pixel to obtain the target prediction value of the current encoding pixel. For example, the processing device may perform a summation processing on the initial prediction value and the adjustment value of the current encoding pixel to obtain the target prediction value of the current encoding pixel. As another example, the processing device may perform a weighted summation processing on the initial prediction value and the adjustment value of the current encoding pixel to obtain the target prediction value of the current encoding pixel.

In order to better understand the above scheme, the following descriptions may be introduced in combination with specific embodiments: assuming that a size of the current encoding block is 4×4, and the current template pixels in the current template are only distributed on a upper side of the current encoding block. An upper-left pixel (position (0,0)) of the current encoding block is adjusted, that is, a current pixel is the upper-left pixel point of the current encoding block. At the same time, assuming that an initial prediction value of the current pixel is 60, a reconstruction pixel value of a reference encoding pixel corresponding to the current pixel is 60, and reconstruction pixel values of four reference template pixels in the reference template from left to right are 20, 30, 40 and 50 in sequence, then from left to right, absolute values corresponding to the four reference template pixels are 40, 30, 20, and 10 in sequence. Assuming that a representative value obtained is equal to the absolute value corresponding to the reference template pixel after the absolute value corresponding to the reference template pixel is inputted into the preset function, then from left to right, representative values corresponding to the four reference template pixels are 40, 30, 20, and 10, and then from left to right, adjustment coefficients corresponding to the four reference template pixels are 0.4, 0.3, 0.2, and 0.1. At the same time, assuming that reconstruction pixel values of the four current template pixels from left to right in the current template are 40, 50, 60, and 70 in sequence, then an adjustment value obtained is A=40×0.4+50×0.3+60×0.2+70×0.1=50. At the same time, assuming that a weight of the adjustment value is 0.4, and a weight of the initial prediction value of the current pixel is 0.6, then the target prediction value of the current pixel is 0.4×50+0.6×60=56.

In some embodiments of the present disclosure, since the greater the gap between the reconstruction pixel value of the reference template pixel and the reconstruction pixel value of the reference encoding pixel, the greater a proportion of a reconstruction pixel value of a corresponding current template pixel in the target prediction value obtained, so a gap between the target prediction value of the current encoding pixel and the reconstruction pixel value of the current template pixel may be reduced, and a jump of a pixel value between pixels may be avoided.

It should be noted that the above description of the process 400 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

In some embodiments, the processing device may obtain a plurality of second products by multiplying a square value of the adjustment coefficient corresponding to the reference template pixel by the reconstruction pixel value of the current template pixel corresponding to the reference template pixel respectively, and determine a sum of the plurality of second products as the adjustment value, so as to obtain the target prediction value of the current pixel according to the adjustment value.

FIG. 16 is a flowchart illustrating an exemplary process for determining a target prediction value of a current encoding pixel according to some embodiments of the present disclosure. In some embodiments, a process 1600 may be executed by the system 100 to determine a reference region. For example, the process 1600 may be implemented as a set of instructions stored in a storage device. In some embodiments, the processing device 140 (e.g., the processor 210 of the computing device 200 and/or one or more modules illustrated in FIG. 3) may execute the set of instructions and may accordingly be directed to perform the process 1600. The operations of the illustrated process presented below are intended to be illustrative. In some embodiments, the process 1600 may be accomplished with one or more additional operations not described and/or without one or more of the operations discussed. Additionally, the order of the operations of process 1600 illustrated in FIG. 16 and described below is not intended to be limiting.

In 1610, an initial reference region is determined in a reference frame according to an initial motion vector corresponding to a current encoding block.

The reference region may include a reference encoding block and/or a reference template region. For example, as shown in FIG. 1, the reference region may include a reference encoding block 121 and a reference template region 122.

The initial reference region refers to a reference encoding block determined based on manners such as motion search and a reference template region corresponding to a current template region. The reference encoding block and the reference template region herein may be called an initial reference encoding block and the initial reference template region.

In some embodiments, a processing device may determine a encoding block closest to the current encoding block in the reference frame by the manners such as motion search, determine the encoding block as the initial reference encoding block, and determine the initial reference template region according to the current template region, and then determine the determined initial reference encoding block and initial reference template region as the initial reference region. For more content on determining the reference encoding block and the reference template region, please refer to FIG. 4 and related descriptions.

In 1620, a plurality of candidate reference regions including the initial reference region is obtained by performing a translation process on the initial reference region in the reference frame.

In some embodiments, the processing device may perform the translation process on the initial reference encoding block in the reference frame with n preset steps and t preset directions, and may obtain (n×t+1) candidate reference encoding blocks including the initial reference encoding block. FIG. 17 is a flowchart illustrating an exemplary process for generating a candidate reference region according to some embodiments of the present specification. For example, as shown in FIG. 17, 2 preset steps (2 pixels and 4 pixels respectively) and 4 preset directions may be set, which are vertically upward, vertically downward, horizontally left, and horizontally right respectively. By translating the initial reference region, nine candidate reference regions including the initial reference region may be obtained.

In 1630, the reference region among the plurality of candidate reference regions is determined.

In some embodiments, the processing device may determine a cost value corresponding to each candidate reference region based on reference templates corresponding to the plurality of candidate reference regions and a current template region of the current encoding block; determine a candidate reference region corresponding to a smallest cost value as the reference region. The cost value corresponding to the candidate reference region is positively correlated with a template gap corresponding to the candidate reference region, and the template gap is a difference between a reference template region corresponding to the candidate reference region and the current template region.

A positive correlation refers that the smaller the template gap corresponding to the candidate reference region, the less the cost value corresponding to the candidate reference region. And if the cost value corresponding to the candidate reference region is less, it means that a difference between the reference template region of the candidate reference region and the current template region of the current encoding block is smaller, and a similarity between the reference template region and the current template region is higher, which further illustrates that the reference encoding block corresponding to the reference region is more similar to the current encoding block, and then the candidate reference region corresponding to the smallest cost value may be determined as the reference region subsequently.

In some embodiments, for each candidate reference region, the processing device may determine the cost value corresponding to the candidate reference region according to the reference template region of the candidate reference region and the current template region.

In some embodiments, the processing device may determine a cost value of the reference template region of the candidate reference region and a cost value of the current template region of the current encoding block based on a cost function, as long as a condition that the smaller the difference between the reference template region of the candidate reference region and the current template region of the current encoding block, the less the cost value corresponding to the candidate reference region can be satisfied. For more details on determining the cost value, please refer to FIG. 4 and its related descriptions.

In some embodiments, in order to indicate a final reference encoding block to a decoder, an encoder may add a syntactic element when transmitting a code stream to the decoder. The syntactic element indicates whether the plurality of candidate reference regions is generated during encoding, that is, whether the steps 1610 to 1630 are performed. Specifically, the syntactic element has two states. When it is the first state, it indicates that the plurality of candidate reference regions are not generated during the encoding, and the final reference region is the initial reference region herein; when it is the second state, it indicates that the plurality of candidate reference regions are generated during the encoding, and a candidate reference region with a greatest similarity to the current encoding block and/or the current template region among the plurality of candidate reference regions is determined as the final reference region herein. When the syntactic element is in the second state, two other syntactic elements may be generated and transmitted: one syntactic element indicates an offset direction of the final reference region (the candidate reference region corresponding to the smallest cost value) relative to the initial reference region, and another syntactic element indicates an offset amount of the final reference region (the candidate reference region corresponding to the smallest cost value) relative to the initial reference region.

In some embodiments of the present disclosure, the plurality of candidate reference regions including the initial reference region is generated by performing the translation process on the initial reference region in the reference frame, and a reference encoding block most similar to the current encoding block is determined among the reference encoding blocks corresponding to the plurality of candidate reference regions. Compared with directly determining the initial reference encoding block as the reference encoding block in the prior art, the above process provided by the present disclosure may avoid errors when determining the initial reference encoding block and affecting the accuracy of subsequent results.

It should be noted that the above description of the process 400 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

In some embodiments, the processing device may directly determine a similarity between the reference encoding block corresponding to each candidate reference region and the current encoding block, and then determine a candidate reference region corresponding to a reference encoding block.

In some embodiments, the processing device may determine the initial reference region in the reference frame according to the initial motion vector corresponding to the current encoding block. The processing device may perform the translation process on the initial reference region in the reference frame to obtain the plurality of candidate reference regions including the initial reference region. Taking each pixel in the current encoding block as a current encoding pixel, a candidate target prediction value of each pixel in the current encoding block in each candidate reference region may be obtained. The processing device may determine the cost value corresponding to each candidate reference region according to a candidate target prediction value of all pixels in the current encoding block in each candidate reference region respectively and determine a candidate target prediction value of each pixel in the candidate reference region corresponding to the smallest cost value as a target prediction value of each pixel respectively. For more descriptions regarding to determining the plurality of candidate reference regions, please refer to the step 1620 and related descriptions.

In some embodiments, the processing device may sequentially use each pixel in the current encoding block as a current pixel. For the current pixel in the current encoding block, the processing device may sequentially use the plurality of candidate reference regions as the reference encoding block and/or the reference template region, and execute the step 430 to the step 440.

For example, assuming that there are three candidate reference regions, which are a first candidate reference region, a second candidate reference region, and a third candidate reference region respectively. Firstly, the first candidate reference region is used as the reference encoding block and/or the reference template region, and the step 430 to the step 440 are executed to obtain a target prediction value of the current pixel in the first candidate reference region. Secondly, the second candidate reference region is used as the reference encoding block and/or reference template region, and the step 430 to step 440 are executed to obtain a target prediction value of the pixel in the second candidate reference region. Thirdly, the third candidate reference region is used as the reference encoding block and/or reference template region, and the step 430 to the step 440 are executed to obtain a target prediction value of the pixel in the third candidate reference region. Therefore, assuming that a count of candidate reference regions is three, so each pixel in the current encoding block has three target prediction values.

In some embodiments, after obtaining target prediction values of all pixels in the current encoding block in a plurality of candidate reference encoding blocks, for any candidate reference region, a cost value of the candidate reference encoding block may be determined according to target prediction values of all pixels in the current encoding block in the candidate reference region, and the cost value is a rate-distortion cost value. For more details about the cost value, please refer to step 1630 and related descriptions.

In some embodiments, the less the cost value corresponding to the candidate reference region, the less the difference between the candidate reference region and the current encoding block, and the greater the similarity between the candidate reference region and the current encoding block. Therefore, for any pixel in the current encoding block, the processing device may determine a candidate target prediction value of each pixel in a candidate reference region corresponding to a minimum cost value as the target prediction value of each pixel.

In some embodiments of the present disclosure, considering that errors may occur when determining the initial reference region, a target prediction value of any pixel in the current encoding block in a reference encoding block that is most similar to the current encoding block may be calculated, and the target prediction value may be determined as the target prediction value of the pixel.

In order to indicate the final reference encoding block to the decoder, the encoder may need to add a syntactic element when passing the code stream to the decoder. The syntactic element is similar to the syntactic element in 1630, which is not repeated herein.

FIG. 18 is a flowchart illustrating an exemplary process for determining a target prediction value of a current encoding pixel according to some embodiments of the present disclosure. In some embodiments, a process 1800 may be executed by the system 100 for determining the target prediction value of the current encoding pixel. For example, the process 1800 may be implemented as a set of instructions stored in a storage device. In some embodiments, the processing device 140 (e.g., the processor 210 of the computing device 200 and/or one or more modules illustrated in FIG. 3) may execute the set of instructions and may accordingly be directed to perform the process 1800. The operations of the illustrated process presented below are intended to be illustrative. In some embodiments, the process 1800 may be accomplished with one or more additional operations not described and/or without one or more of the operations discussed. Additionally, the order of the operations of the process 1800 illustrated in FIG. 18 and described below is not intended to be limiting.

In 1810, for each of at least one current template pixel, a prediction value adjustment model is constructed according to a reconstruction pixel value of the current template pixel and reconstruction pixel values of a plurality of corresponding reference template pixels.

Reconstruction pixel values of a plurality of reference encoding pixels may include a reconstruction pixel value of an initial reference encoding pixel and a reconstruction pixel value of pixels surrounding the initial reference encoding pixel. The initial reference encoding pixel is a pixel corresponding to the current encoding pixel in a reference encoding block.

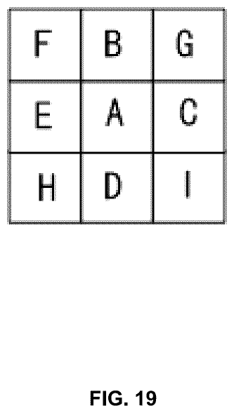

FIG. 19 is a schematic diagram illustrating an exemplary initial reference encoding pixel and surrounding pixels of the initial reference encoding pixel according to some embodiments of the present disclosure. For example, as shown in FIG. 19, all surrounding pixels of an initial reference template pixel and the initial reference template pixel form a “nine square grid”. Pixel A is an initial reference template pixel corresponding to the current template pixel, and at least one pixel surrounding the initial reference template pixel includes at least one pixel among pixel B, pixel C, pixel D, pixel E, pixel F, pixel G, pixel H, and pixel I. That is to say, a reconstruction pixel value of the plurality of reference template pixels corresponding to the current template pixel includes reconstruction pixel values of a plurality of pixels among pixel A, pixel B, pixel C, pixel D, pixel E, pixel F, pixel G, pixel H, and pixel I herein.

In some embodiments, the processing device may classify the reference template pixel based on the reconstruction pixel value of the reference template pixel to obtain at least one reference template pixel type. In a current template, a current pixel type corresponding to each reference template pixel type is determined respectively, a current template pixel in the current pixel type is in one-to-one correspondence to a reference template pixel in a corresponding reference template pixel type, and the current template pixel corresponding to the reference template pixel is a pixel in the current template with a same position as the reference template pixel. A prediction value adjustment model corresponding to each current pixel type is constructed according to the reconstruction pixel value of the current template pixel in each current pixel type and a reconstruction pixel value of each of at least one corresponding reference template pixel. For more descriptions regarding to the target prediction value of the current encoding pixel, please refer to FIG. 4 and its related descriptions.

In some embodiments, the processing device may construct the prediction value adjustment model according to reconstruction pixel values of all current template pixels and reconstruction pixel values of a plurality of reference template pixels corresponding to each current template pixel. In some embodiments, the processing device may construct the prediction value adjustment model according to reconstruction pixel values of some of the current template pixels and reconstruction pixel values of a plurality of reference template pixels corresponding to the some of the current template pixels respectively.

The reconstruction pixel values of the plurality of reference template pixels corresponding to the current template pixel may be preset or determined according to parameters such as texture and size of the current encoding block. For example, as shown in FIG. 5, when the texture of the current encoding block is determined as a horizontal texture, the processing device may designate the reconstruction pixel values of the plurality of reference template pixels corresponding to the current template pixel as reconstruction pixel values of pixels including pixels E, A, and C.

In the prior art, constructing a prediction model is to construct a model only based on the reconstruction pixel value of the current template pixel and a reconstruction pixel value of the initial reference template pixel. Such a process of construction only considers a relationship between the current template pixel and the initial reference template pixel, which has limitations and may eventually cause an inaccurate prediction result and affect the visual effect of the image transmitted.

In 1820, the target prediction value is determined by adjusting, based on an initial prediction value of the current encoding pixel and reconstruction pixel values of a plurality of reference encoding pixels corresponding to the current encoding pixel, the initial prediction value according to the prediction value adjustment model.

In some embodiments, the prediction value adjustment model described above includes a non-linear model. An initial prediction value of the current encoding block includes the initial prediction value of the current encoding pixel.

The reconstruction pixel values of the plurality of reference encoding pixels may include a reconstruction pixel value of an initial reference encoding pixel and reconstruction pixel values of pixels surrounding the initial reference encoding pixel. The initial reference encoding pixel is a pixel corresponding to the current encoding pixel in the reference encoding block.

In some embodiments, the processing device may determine the target prediction value of the current encoding pixel according to a plurality of target values and a plurality of model parameters. The plurality of target values is in one-to-one correspondence with the plurality of model parameters (i.e., a determination that which target value parameters are used is determined by the plurality of model parameters, and the model parameter is determined by a process of constructing the prediction value adjustment model). The plurality of target values may include a plurality of values among operation values and reconstruction pixel values of the plurality of reference encoding pixels corresponding to the current encoding pixel. The operation value is obtained by operating the reconstruction pixel value of the reference encoding pixel. The reconstruction pixel value of the plurality of reference encoding pixels includes the reconstruction pixel value of the initial reference encoding pixel and the reconstruction pixel values of the pixels surrounding the initial reference encoding pixel. The initial reference encoding pixel is a pixel corresponding to the current encoding pixel in the reference encoding block.

The operation value is obtained by operating the reconstruction pixel value of the reference encoding pixel. For example, the processing device may input the reconstruction pixel value of the reference encoding pixel into a preset function to obtain the operation value. The preset function may include an identity function, a square function, an absolute value function, or the like.

In some embodiments, the processing device may obtain a plurality of second products by multiplying the reconstruction pixel value of the plurality of reference encoding pixels by model parameters corresponding to the plurality of reference encoding pixels respectively, and sum all the plurality of second products to determine the target prediction value.

For example, the processing device may determine a target prediction value y of the current encoding pixel based on the following model formula:

$$y = {p}_{1} {X}_{1} + {p}_{2} {X}_{2} + … + {p}_{i} {X}_{i} + …… {p}_{n} {X}_{n} ,$$

Where, p₁, p₂, . . . , pᵢ, . . . , and pₙ represent the plurality of model parameters respectively, X₁, X₂, . . . , Xᵢ, . . . , and Xₙ respectively represent the plurality of target values, and a model parameter pᵢ is in one-to-one correspondence with a target value Xᵢ.

That is to say, the plurality of second products is obtained by multiplying the plurality of target values by a plurality of model parameters corresponding to the plurality of target values; then a sum of all the plurality of second products is determined as the target prediction value of the current encoding pixel.

In some implementations, after obtaining the sum of all the second products, the processing device may further perform a series of calculations on the sum, to obtain the target prediction value of the current encoding pixel.

In some embodiments, the processing device may also use other model formulas to calculate the target prediction value of the current encoding pixel. For example, as shown in FIG. 19, assuming that a pixel A is the initial reference encoding pixel, then the above model formulas may be set as follows:

$$a = {p}_{1} A + {p}_{2} B + {p}_{3} C + {p}_{4} D + {p}_{5} E + {p}_{6} c ; \qquad Model formula 1$$

$$a = {p}_{1} A + {p}_{2} {B}^{2} + {p}_{3} c ; \qquad Model formula 2$$

$$a = {p}_{1} A + {p}_{2} B + {p}_{3} C + {p}_{4} D + {p}_{5} E + {p}_{6} c + {p}_{7} {A}^{2} ; \qquad Model formula 3$$

$$a = {p}_{1} A + {p}_{2} B + {p}_{3} C + {p}_{4} D + {p}_{5} E + {p}_{6} F + {p}_{7} G + {p}_{8} H + {p}_{9} I + {p}_{10} c ; \qquad Model formula 4$$

Where, a denotes the target prediction value of the current encoding pixel, A, B, C, D, E, F, G, H, and I denote reconstruction pixel values of pixels A, B, C, D, E, F, G, H, and I respectively, and c denotes a preset constant value.

That is to say, as shown in FIG. 19, the processing device may use any one of the above model formulas to determine the target prediction value of the current encoding pixel, and other model formulas may also be used to determine the target prediction value of the current encoding pixel. It can be seen from the above that the essence of prediction by using the prediction value adjustment model is to use the model formula for calculation, and a purpose of constructing the prediction value adjustment model is to determine a plurality of model parameters in the model formula.

In order to illustrate, the following examples are used for illustration:

In some embodiments, when determining the target prediction value of the current encoding pixel, if the above model formula 1 is used to determine the target prediction value of the current encoding pixel, the process of constructing the prediction value adjustment model includes determining six model parameters (i.e., p₁ to p₆) in a model formula: y=p₁X₁+p₂ X₂+p₃X₃+p₄X₄+p₅ X₅+p₆c. Specifically, assuming that the pixel A in FIG. 19 is the initial reference encoding pixel corresponding to the current template pixel, then for a plurality of current template pixels, the reconstruction pixel value of the current template pixel is inputted into the above model formula as y, and a reconstruction pixel value of the pixel A is inputted into as X₁, a reconstruction pixel value of the pixel B is inputted into as X₂, a reconstruction pixel value of the pixel C is inputted into as X₃, a reconstruction pixel value of the pixel D is inputted into as X₄, a reconstruction pixel value of the pixel E is inputted into as X₅, so that a plurality of equations may be obtained, and then after a fitting process, values of the p₁ to p₆ are obtained. Finally, the model formula 1 may be used to predict the current encoding pixel.

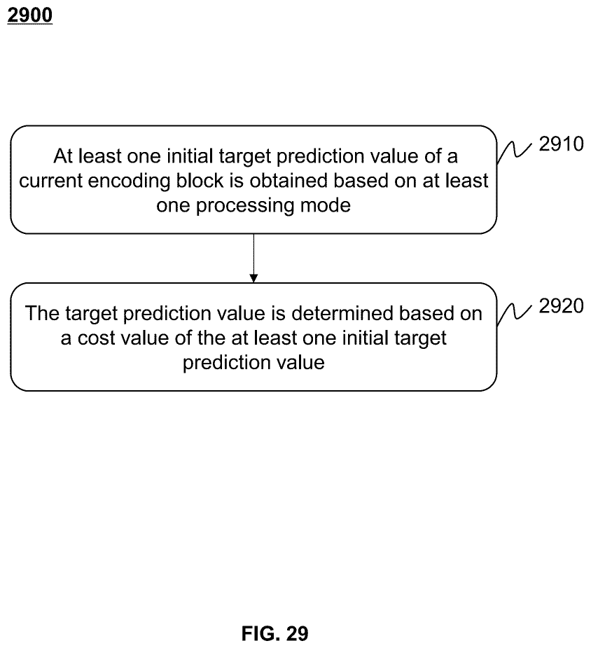

In some embodiments, after constructing the prediction value adjustment model into a plurality of different candidate prediction value models sequentially, the processing device may determine target prediction values of all current encoding pixels in each candidate prediction value model respectively. Next, according to the target prediction values of all the current encoding pixels in each candidate prediction value model, a cost value corresponding to each candidate prediction value model is determined respectively. Next, a candidate prediction value adjustment model with a smallest cost value is determined as the prediction value adjustment model, and a target prediction value of each current encoding pixel in a final prediction model is determined as a final target prediction value of each current encoding pixel. For more details about determining the target prediction value based on the cost value, please refer to FIG. 29 and its related descriptions.

In some embodiments of the present disclosure, when constructing the prediction value model, instead of only considering the initial reference template pixel, the reconstruction pixel values of the pixels surrounding the initial reference template pixel and the reconstruction pixel values of the initial reference template pixel are combined together. Therefore, the accuracy rate of the prediction value adjustment model constructed may be improved, the accuracy rate of finally predicting the current encoding pixel may be improved, and the effect of a final image transmission may be guaranteed.

It should be noted that the above description of the process 400 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

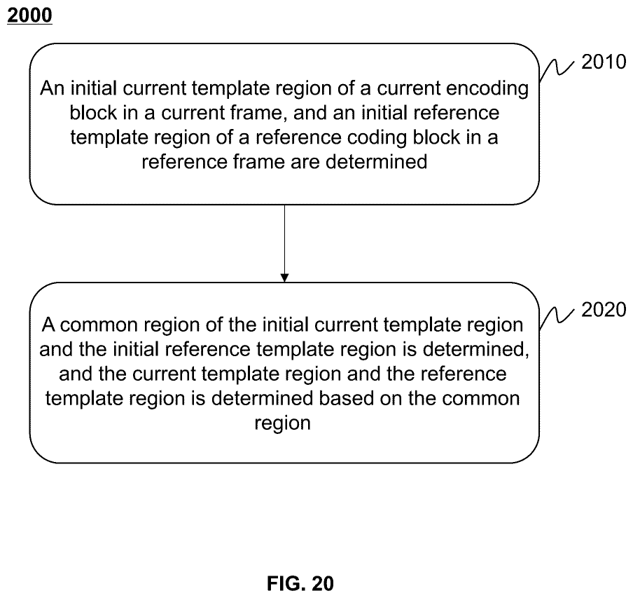

FIG. 20 is a flowchart illustrating an exemplary process for determining a target prediction value of a current encoding pixel according to some embodiments of the present disclosure. In some embodiments, a process 2000 may be executed by the system 100 for determining a current template region and a reference template region. For example, the process 2000 may be implemented as a set of instructions stored in a storage device. In some embodiments, the processing device 140 (e.g., the processor 210 of the computing device 200 and/or one or more modules illustrated in FIG. 3) may execute the set of instructions and may accordingly be directed to perform the process 2000. The operations of the illustrated process presented below are intended to be illustrative. In some embodiments, the process 2000 may be accomplished with one or more additional operations not described and/or without one or more of the operations discussed. Additionally, the order of the operations of the process 2000 illustrated in FIG. 20 and described below is not intended to be limiting.

In 2010, an initial current template region of a current encoding block in a current frame, and an initial reference template region of a reference encoding block in a reference frame are determined.

The initial current template region may include at least one among a first sub-region, a second sub-region, a third sub-region, a fourth sub-region, and a fifth sub-region outside the current encoding block. The first sub-region is located on a first side of the current encoding block and two ends of the first sub-region are flush with two ends of the current encoding block respectively. The second sub-region is located on a second side of the current encoding block and two ends of the second sub-region are flush with the two ends of the current encoding block respectively. The third sub-region connects the first sub-region and the second sub-region. The fourth sub-region is located on a side of the first sub-region away from the third sub-region. The fifth sub-region is located on a side of the second sub-region away from the third sub-region.

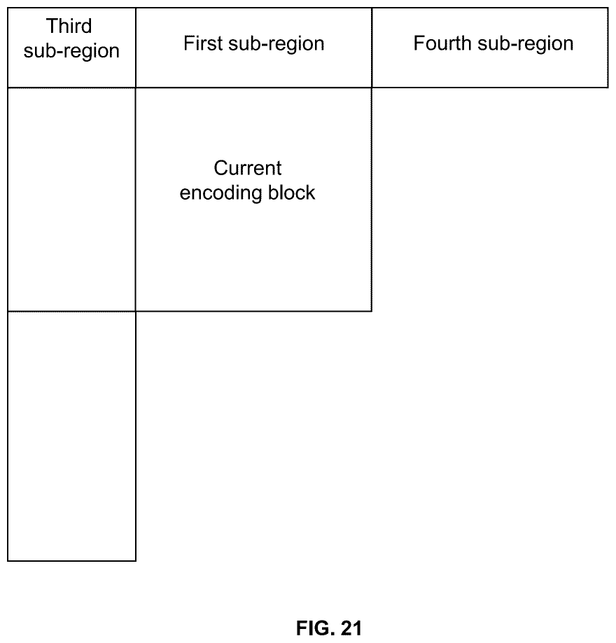

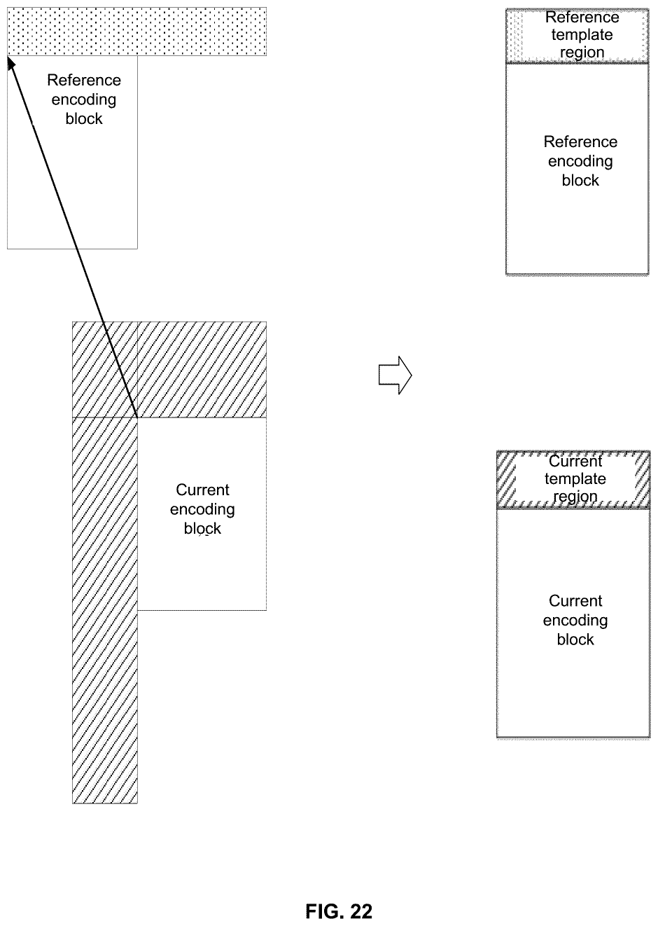

FIG. 21 is a schematic diagram illustrating a current encoding block and an initial current template region outside the current encoding block according to some embodiments of the present specification. For example, as shown in FIG. 21, the initial current template region outside the current encoding block may include the at least one sub-region among the first sub-region, the second sub-region, the third sub-region, the fourth sub-region, and the fifth sub-region. The initial current template region may be preset or may be determined according to parameters such as texture and size of the current encoding block.

A width of the first sub-region and the fourth sub-region may be equal to a width of the current encoding block, and a height of the second sub-region and the fifth sub-region may be equal to a height of the current encoding block. Heights of the first sub-region and the fourth sub-region are equal, and widths of the second sub-region and the fifth sub-region are equal. The height of the first sub-region and the fourth sub-region may be determined according to an actual need, and the width of the second sub-region and the fifth sub-region may also be determined according to the actual need. For example, the first sub-region and the fourth sub-region are determined to include 6 rows of pixels, and the second sub-region and the fifth sub-region are determined to include 6 columns of pixels.

The initial reference template region refers to an area relative to the initial current template area. The initial reference template region is similar to the initial current template region, which is not repeated herein.

After determining the initial current template region and the initial reference template region, a processing device may determine reconstruction pixels in the initial current template region outside the current encoding block as pixels in a current template, and determine reconstruction pixels in the initial reference template region outside the reference encoding block as pixels in a reference template respectively. Referring to FIG. 1, in the prior art, the initial current template region and the initial reference template region is determined to include the first sub-region and the second sub-region. The first sub-region only includes a row of pixels and the second sub-region only includes a column of pixels, more space information cannot be used. However, in the present disclosure, the initial current template region and the initial reference template region is determined according to the above process, which may make full use of the space information and ensure the accuracy of a final prediction result.

In 2020, a common region of the initial current template region and the initial reference template region is determined, and the current template region and the reference template region is determined based on the common region.

In some embodiments, it may be considered that there may be reconstruction pixels that cannot be obtained in the current encoding block, the initial current template region outside the reference encoding block, and/or the initial reference template region. For example, if the current encoding block, the initial current template region outside the reference encoding block, and/or the initial reference template region exceed a boundary, only part of the reconstruction pixels in the current encoding block, the initial current template region outside the reference encoding block and/or the initial reference template region may be obtained at this time, so that reconstruction pixels that can be obtained in the initial current template region outside the current encoding block may not correspond to reconstruction pixels that can be obtained in the initial reference template region outside the reference encoding block. Based on the above reasons, the processing device may determine a first valid region outside the current encoding block, and determine a second valid region outside the reference encoding block. Then the processing device may determine a common region of the first valid region and the second valid region, and determine the current template region and the reference template region based on reconstruction pixels in a common region outside the current encoding block and the reference encoding block. The first valid region is located in the initial current template region outside the current encoding block, and the first valid region includes reconstruction pixels that can be obtained outside the current encoding block. The second valid region is located in the initial reference template region outside the reference encoding block, and the second valid region includes reconstruction pixels that can be obtained outside the reference encoding block.

FIG. 22 is a flowchart illustrating an exemplary process for determining the current template region and a reference template region corresponding to FIG. 21 according to some embodiments of the present disclosure. For example, as shown in FIG. 22, a region filled with oblique lines outside the current encoding block is the first valid region outside the current encoding block, and a region filled with dots outside the reference encoding block is the second valid region outside the reference encoding block. Assuming that reconstruction pixels in a first region above the current encoding block, a second region on the left of the current encoding block, a third region above the reference encoding block, and a fourth region on the left of the reference encoding block are obtained at most. The first region includes 6 rows, and a width of the first region is doubling a width of the current encoding. The second region includes 6 rows and with a width of the second region is twice the width of the current encoding block. The third region includes 6 rows and a width of the third region is twice a width of the reference encoding block. The fourth region includes 0 rows. Thus, the common region of the first valid region and the second valid region is a region includes 4 rows above the current encoding block and a width of the region is doubling the width of the current encoding block. Then the processing device may determine the reconstruction pixels in the common region outside the current encoding block and the reference encoding block as pixels in the current template and the reference template respectively, and finally use the pixels to construct a model.

In some embodiments of the present disclosure, after the initial current template region and the initial reference template region are determined, the processing device may determine the common region of the initial current template region and the initial reference template region as the current template region and the reference template region. While making full use of the space information, the above process avoids a problem that the reconstruction pixels that obtained in the initial current template region outside the current encoding block cannot correspond to the reconstruction pixels that obtained in the initial reference template region outside the reference encoding block, and the above process ensures the accuracy of the final prediction result.

It should be noted that the above description of the process 400 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

In some embodiments, the processing device may determine at least one candidate region based on the initial current template region and the initial reference template region. The candidate region includes at least one candidate current template region, and at least one candidate reference region corresponding to the at least one candidate current template region. The processing device may determine a candidate target prediction value of each current encoding pixel in each candidate region. The processing device may determine a cost value corresponding to each candidate region according to the candidate target prediction value of the each current encoding pixel in the each candidate region. The processing device may determine a candidate region with a smallest cost value as a final region, and the final region includes the current template region and the reference template region. The processing device may determine a candidate target prediction value of the each current encoding pixel in the final region as a target prediction value of the each current encoding pixel.

Sub-regions included in a plurality of candidate regions may be different. For example, one candidate region includes the first sub-region, the third sub-region, and the fourth sub-region, another candidate region includes the second sub-region, the third sub-region, and the fifth sub-region, and another candidate region includes the first sub-region, the second sub-region, the third sub-region, the fourth sub-region, and the fifth sub-region. For more details about determining the target prediction value based on the cost value, please refer to FIG. 29 and its related descriptions.

FIG. 23 is a flowchart illustrating an exemplary process for determining a target prediction value of a current encoding pixel according to some embodiments of the present disclosure. In some embodiments, a process 2300 may be executed by the system 100 for determining a target prediction value of a second encoding block. For example, the process 2300 may be implemented as a set of instructions stored in a storage device. In some embodiments, the processing device 140 (e.g., the processor 210 of the computing device 200 and/or one or more modules illustrated in FIG. 3) may execute the set of instructions and may accordingly be directed to perform the process 2300. The operations of the illustrated process presented below are intended to be illustrated. In some embodiments, the process 2300 may be accomplished with one or more additional operations not described and/or without one or more of the operations discussed. Additionally, the order of the operations of the process 2300 illustrated in FIG. 23 and described below is not intended to be limiting.

In some embodiments, a current encoding block my include a first encoding block and a second encoding block. The first encoding block may be a first color component block and the second encoding block my be a second color component block.

In some embodiments, the first encoding block my be a brightness block, and the second encoding block may be a chroma block corresponding to the first encoding block. In some embodiments, the first encoding block my be a chroma block, and the second encoding block my be a brightness block or a chroma block corresponding to the first encoding block.

In 2310, a target prediction value of a first encoding block is obtained.

In some embodiments, the processing device may obtain the target prediction value of the first encoding block based on a processing mode corresponding to any embodiments of determining a target prediction value in FIGS. 4 to 22.

In 2320, a prediction value adjustment model of the second encoding block is constructed according to reconstruction pixel data in a current template region of the first encoding block and the reconstruction pixel data in a current template region of the second encoding block.

In some embodiments, a process of constructing the prediction value adjustment model of the second encoding block may refer to a process of constructing a prediction value adjustment model in FIG. 18. For example, as shown in FIG. 19, when constructing a model, the model may be constructed according to the following model formula:

$$a = {p}_{1} A + {p}_{2} B + {p}_{3} C + {p}_{4} D + {p}_{5} E + {p}_{6} {A}^{2} + {p}_{7} F .$$

In 2330, the target prediction value of the second encoding block is obtained according to the prediction value adjustment model of the second encoding block and the target prediction value of the first encoding block.

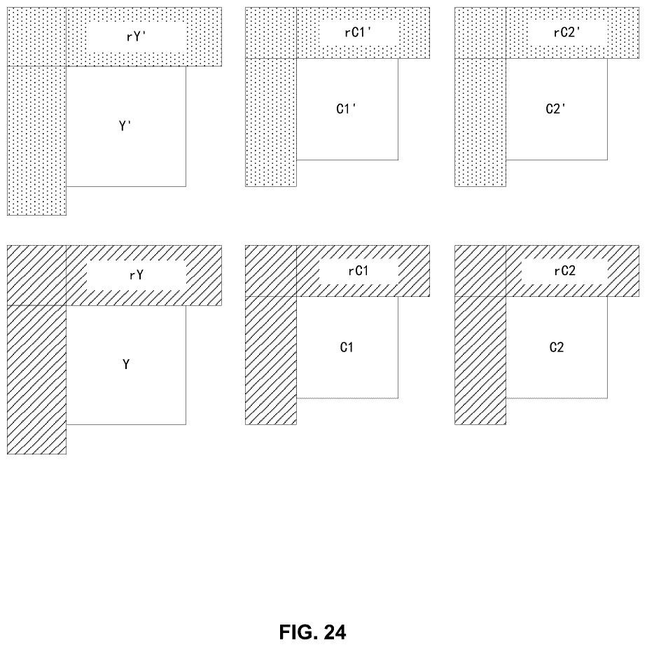

FIG. 24 is a schematic diagram illustrating exemplary current encoding blocks of three color components and their respective reference encoding block, current template region, and reference template region according to some embodiments of the present disclosure. As shown in FIG. 24, an encoding block of a luma block is represented by Y, and two encoding blocks of a chroma block are represented by C1 and C2 respectively.

In some embodiments, if Y is used as the first encoding block, then a process of predicting rC1 based on rY is used to construct a model, and then the model is applied to Y to obtain a prediction value of each pixel in C1, and a process of predicting rC2 based on rY is used to construct a model, and then the model is applied to Y to obtain a prediction value of each pixel in C2.

In some embodiments, if C1 is used as the first encoding block, then a process of predicting rC2 based on rC1 is used to construct a model, and then the model is applied to predict C2 based on C1 and obtain the prediction value of each pixel in C2; or C2 is used as the first encoding block, and a process of predicting rC1 based on rC2 is used to construct a model, and then the model is applied to predict C1 based on C2 and obtain the prediction value of each pixel in C1.

In some embodiments, if C1 is used as the first encoding block, then a process of predicting rY based on rC1 is used to construct a model, and then the model is applied to predict Y based on C1 and obtain a prediction value of each pixel in Y.

In some embodiments, if C2 is used as the first encoding block, a process of predicting rY based on rC2 is used to construct a model, and then the model is applied to predict Y based on C2 and obtain the prediction value of each pixel in Y.

If Y is used as the second encoding block, in order to improve the prediction accuracy, C1 is firstly used as the first encoding block to obtain the prediction value of each pixel in Y, and then C2 is used as the first encoding block to obtain the prediction value of each pixel in Y, then a final prediction result is obtained by integrating the two prediction results.

In some embodiments of the present disclosure, combining the luma block and the chrome block to determine the target prediction value may improve the accuracy of prediction and ensure the effect of final image transmission.

It should be noted that the above description of the process 400 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

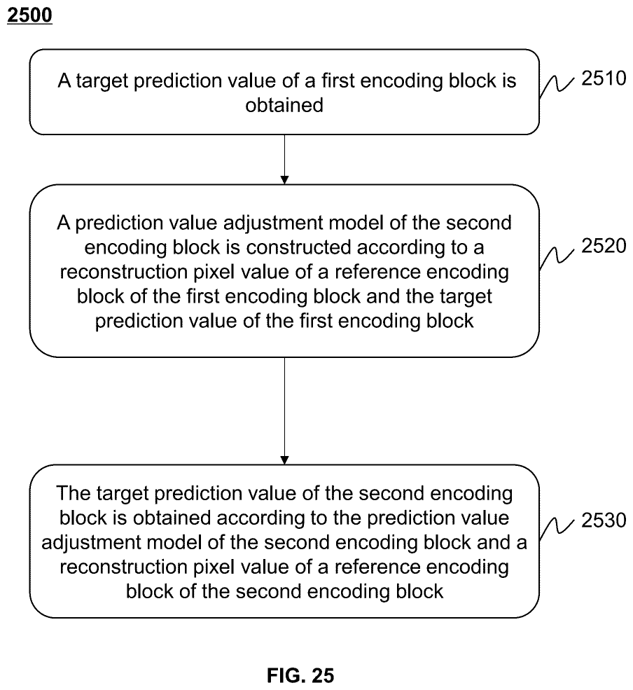

FIG. 25 is a flowchart illustrating an exemplary process for determining a target prediction value of a current encoding pixel according to some embodiments of the present disclosure. In some embodiments, a process 2500 may be executed by the system 100 for determining a target prediction value of a second encoding block. For example, the process 2500 may be implemented as a set of instructions stored in a storage device. In some embodiments, the processing device 140 (e.g., the processor 210 of the computing device 200 and/or one or more modules illustrated in FIG. 3) may execute the set of instructions and may accordingly be directed to perform the process 2500. The operations of the illustrated process presented below are intended to be illustrated. In some embodiments, the process 2500 may be accomplished with one or more additional operations not described and/or without one or more of the operations discussed. Additionally, the order of the operations of the process 2500 illustrated in FIG. 25 and described below is not intended to be limiting.

In 2510, a target prediction value of a first encoding block is obtained.

A process of obtaining the target prediction value of the first encoding block in the step 2510 is similar to a process in the step 2310, which is not repeated herein.

In 2520, a prediction value adjustment model of the second encoding block is constructed according to a reconstruction pixel value of a reference encoding block of the first encoding block and the target prediction value of the first encoding block.

A process of constructing the prediction value adjustment model of the second encoding block in the step 2520 is similar to a process of the step 2320, which is not repeated herein.

In 2530, the target prediction value of the second encoding block is obtained according to the prediction value adjustment model of the second encoding block and a reconstruction pixel value of a reference encoding block of the second encoding block.

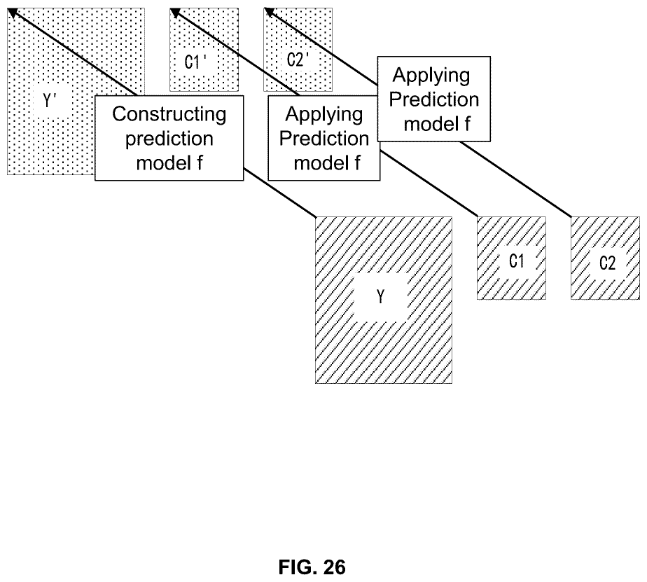

Referring to FIG. 24, in some embodiments, if Y is used as the first encoding block, then a process of predicting Y based on Y′ is used to construct a model, and then the model is applied to predict C1 based on C1′, and the model is applied to predict C2 based on C2′ at the same time. The process may be represented by FIG. 26 herein. FIG. 26 is a flowchart illustrating an exemplary process for determining the target prediction value of the current encoding pixel according to some embodiments of the present disclosure.

In some embodiments, if C1 is used as the first encoding block, a process of predicting C1 based on C1′ is used to construct a model, then the model is applied to predict C2 based on C2′.

In some embodiments, if C2 is used as the first encoding block, a process of predicting C2 based on C2′ is used to construct a model, then the model is applied to predict C1 based on C1′.

In some embodiments, if C1 is used as the first encoding block, the process of predicting C1 based on C1′ is used to construct a model, then the model is applied to predict Y based on Y′.

In some embodiments, if C2 is used as the first encoding block, the process of predicting C2 based on C2′ is used to construct a model, then the model is applied to predict Y based on Y′.

If Y is used as the second encoding block, in order to improve the prediction accuracy, C1 is firstly used as the first encoding block to obtain a prediction value of each pixel in Y, and then C2 is used as the first encoding block to obtain a prediction value of each pixel in Y, then a final prediction result is obtained by integrating the two prediction results.

In some embodiments of the present disclosure, combining the luma block and the chrome block to determine the target prediction value can improve the accuracy of prediction and ensure the effect of final image transmission.

It should be noted that the above description of the process 400 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

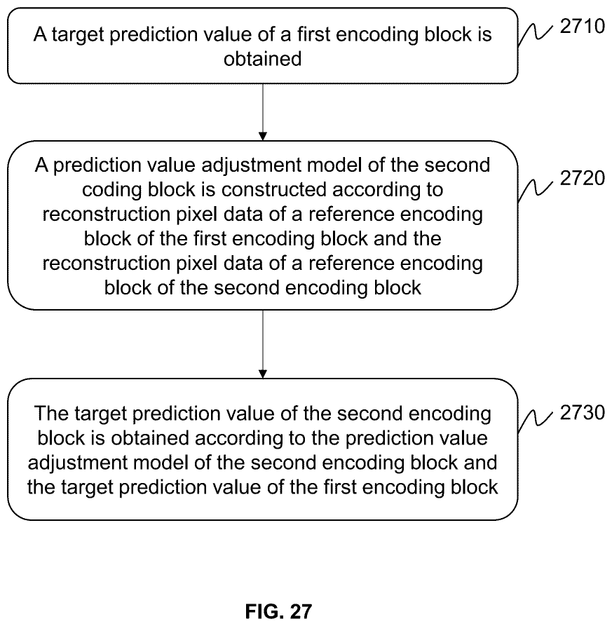

FIG. 27 is a flowchart illustrating an exemplary process for determining a target prediction value of a current encoding pixel according to some embodiments of the present disclosure. In some embodiments, a process 2700 may be executed by the system 100 for determining a target prediction value of a second encoding block. For example, the process 2700 may be implemented as a set of instructions stored in a storage device. In some embodiments, the processing device 140 (e.g., the processor 210 of the computing device 200 and/or one or more modules illustrated in FIG. 3) may execute the set of instructions and may accordingly be directed to perform the process 2700. The operations of the illustrated process presented below are intended to be illustrated. In some embodiments, the process 2700 may be accomplished with one or more additional operations not described and/or without one or more of the operations discussed. Additionally, the order of the operations of the process 2700 illustrated in FIG. 27 and described below is not intended to be limiting.

In 2710, a target prediction value of a first encoding block is obtained.

A process of obtaining the target prediction value of the first encoding block in the step 2710 is similar to a process in the step 2310, which is not limited herein.

In 2720, a prediction value adjustment model of the second encoding block is constructed according to reconstruction pixel data of a reference encoding block of the first encoding block and the reconstruction pixel data of a reference encoding block of the second encoding block.

A process of constructing the prediction value adjustment model of the second encoding block in the step 2720 is similar to a process in the step 2320, which is not limited herein.

In 2730, the target prediction value of the second encoding block is obtained according to the prediction value adjustment model of the second encoding block and the target prediction value of the first encoding block.

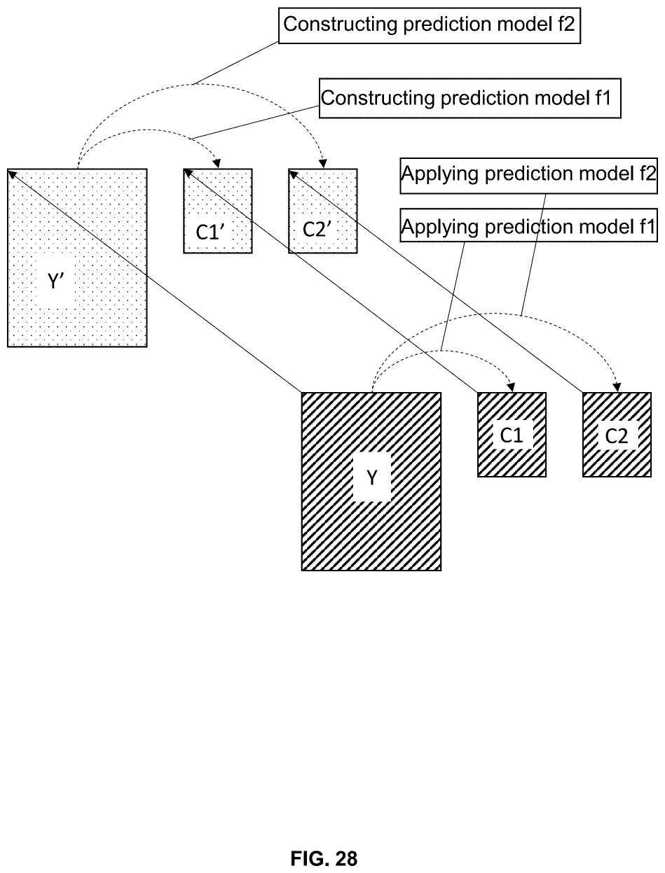

Referring to FIG. 24, in some embodiments, if Y is used as the first encoding block, and a process of predicting C1′ based on Y′ is used to construct a model, then the model is applied to predict C1 based on Y; a process of predicting C2′ based on Y′ is used to construct a model, and the model is applied to predict C2 based on Y at the same time. The process may be represented by FIG. 28 herein. FIG. 28 is a flowchart illustrating an exemplary process for determining the target prediction value of the current encoding pixel according to some embodiments of the present disclosure.

In some embodiments, if C1 is used as the first encoding block, a process of predicting C2′ based on C1′ is used to construct a model, then the model is applied to predict C2 based on C1.

In some embodiments, if C2 is used as the first encoding block, a process of predicting C1′ based on C2′ is used to construct a model, then the model is applied to predict C1 based on C2.

In some embodiments, if C1 is used as the first encoding block, a process of predicting Y′ based on C1′ is used to construct a model, then the model is applied to predict Y based on C1.

In some embodiments, if C2 is the first encoding block, a process of predicting Y′ based on C2′ is used to construct a model, then a model is applied to predict Y′ based on C2.

If Y is used as the second encoding block, in order to improve the prediction accuracy, C1 is firstly used as the first encoding block to obtain a prediction value of each pixel in Y, and then C2 is used as the first encoding block to obtain a prediction value of each pixel in Y, then a final prediction result is obtained by integrating the two prediction results.

In some embodiments of the present disclosure, combining the luma block and the chrome block to determine the target prediction value may improve the accuracy of prediction and ensure the effect of final image transmission.

It should be noted that the above description of the process 400 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

FIG. 29 is a flowchart illustrating an exemplary process for determining a target prediction value according to some embodiments of the present disclosure. In some embodiments, a process 2900 may be executed by the system 100 to determine the target prediction value. For example, the process 2900 may be implemented as a set of instructions stored in a storage device. In some embodiments, the processing device 140 (e.g., the processor 210 of the computing device 200 and/or one or more modules illustrated in FIG. 3) may execute the set of instructions and may accordingly be directed to perform the process 2900. The operations of the illustrated process presented below are intended to be illustrative. In some embodiments, the process 2900 may be accomplished with one or more additional operations not described and/or without one or more of the operations discussed. Additionally, the order of the operations of the process 2900 illustrated in FIG. 29 and described below is not intended to be limiting.

In 2910, at least one initial target prediction value of a current encoding block is obtained based on at least one processing mode.

The at least one processing mode refers to a processing mode corresponding to any embodiments of determining a target prediction value of FIGS. 4 to 28. In different processing modes, steps or parameters of an encoding process are different.

In some embodiments, a processing device may perform an encoding process on the current encoding block based on the at least one processing mode, to determine the at least one initial target prediction value of the current encoding block.

In 2920, the target prediction value is determined based on a cost value of the at least one initial target prediction value.

In some embodiments, the processing device may determine the cost value of the at least one initial target prediction value based on a cost function. For more details on determining the cost value, please refer to FIG. 4 and its related descriptions.

In some embodiments, the processing device may compare the cost value of the at least one initial target prediction value, and determine an initial target prediction value with a smallest cost value as the target prediction value.

When the at least one initial target prediction value of the current encoding block is obtained based on the at least one processing mode for competition, a syntactic element is generated in order to inform a decoder of a final competition result.

In some embodiments, in order to inform a decoding end of a final prediction result, a syntactic element is generated at this time, and the syntactic element is indicative of selecting an initial target prediction value obtained based on one of the plurality of processing modes as the target prediction value. For example, a cost value of a first processing mode is recorded as RDcost1, a cost value of a second processing mode is recorded as RDcost2, and a cost value of a third processing mode is recorded as RDcost3 . . . , if RDcost1 is the smallest, it indicates that the target prediction value is an initial target prediction value obtained based on the first processing mode. At this time, in this syntactic element, a syntax of “apply_ext_mmlic” may be set. When “apply_ext_mmlic” is equal to 1, it indicates that the target prediction value is the initial target prediction value obtained based on the first processing mode; when “apply_ext_mmlic” is equal to 2, it indicates the target prediction value is an initial target prediction value obtained based on the second processing mode; when “apply_ext_mmlic” is equal to 3, it indicates that the target prediction value is an initial target prediction value obtained based on the third processing mode.

In some embodiments of the present disclosure, the target predictive value is determined through the cost value of the at least one initial target prediction value obtained based on the at least one processing mode, so that an accurate target prediction value may be determined.

It should be noted that the above description of the process 400 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

In some embodiments, a user may designate an initial target prediction value obtained based on a certain processing mode as the target prediction value. For example, the processing device may directly determine an initial prediction value of a current encoding block as a final result, that is, the initial prediction value of the current encoding block is determined as the target prediction value.

In some embodiments, the processing device may obtain encoding data of a video, and obtaining the video data by performing a decoding process corresponding to an encoding process on the encoding data.

The encoding process is performed based on a processing mode corresponding to any embodiments of determining the target prediction value in FIGS. 4 to 29.

In some embodiments, a video decoding system may include a decoding module. The decoding module may be configured to obtain the encoding data of a video, and the video data is obtained by performing the decoding process corresponding to the encoding process on the encoding data.

In some embodiments, the present disclosure provides a video encoding system includes at least one storage medium, the storage medium including an instruction set for a video encoding; at least one processor, the at least one processor being in communication with the at least one storage medium, wherein, when executing the instruction set, the at least one processor is configured to: obtain current template reconstruction data, the current template reconstruction data including reconstruction pixel data of a current template region in a current frame related to a current encoding block; obtain reference template reconstruction data, the reference template reconstruction data including reconstruction pixel data of a reference template region in a reference frame related to a reference encoding block, the current template region corresponding to the reference template region; obtain a prediction value adjustment model of the current encoding block based on the current template reconstruction data and the reference template reconstruction data; obtain an initial prediction value of the current encoding block, and determine a target prediction value by adjusting, based on the initial prediction value, the initial prediction value according to the prediction value adjustment model; and determine encoding data of the current encoding block based on the target prediction value.

In some embodiments, the present disclosure provides a non-transitory computer-readable storage medium storing computer instructions, wherein when the computer instructions are executed by a processor, the processor executes a method that includes: obtaining current template reconstruction data, the current template reconstruction data including reconstruction pixel data of a current template region in a current frame related to a current encoding block; obtaining reference template reconstruction data, the reference template reconstruction data including reconstruction pixel data of a reference template region in a reference frame related to a reference encoding block, the current template region corresponding to the reference template region; obtaining a prediction value adjustment model of the current encoding block based on the current template reconstruction data and the reference template reconstruction data; obtaining an initial prediction value of the current encoding block, and determining a target prediction value by adjusting, based on the initial prediction value, the initial prediction value according to the prediction value adjustment model; and determining encoding data of the current encoding block based on the target prediction value.

In some embodiments, the present disclosure provides a video decoding system, comprising: at least one storage medium, the storage medium including an instruction set for a video decoding; at least one processor, the at least one processor being in communication with the at least one storage medium, wherein when executing the instruction set, the at least one processor is configured to: obtain encoding data of a video, and obtain video data by performing a decoding process corresponding to an encoding process on the encoding data, wherein the encoding process includes: obtaining current template reconstruction data, the current template reconstruction data including reconstruction pixel data of a current template region in a current frame related to a current encoding block; obtaining reference template reconstruction data, the reference template reconstruction data including reconstruction pixel data of a reference template region in a reference frame related to a reference encoding block, the current template region corresponding to the reference template region; obtaining a prediction value adjustment model of the current encoding block based on the current template reconstruction data and the reference template reconstruction data; obtaining an initial prediction value of the current encoding block, and determining a target prediction value by adjusting, based on the initial prediction value, the initial prediction value according to the prediction value adjustment model; and determining encoding data of the current encoding block based on the target prediction value.

In some embodiments, the present disclosure provides a non-transitory computer-readable storage medium storing computer instructions, wherein when the computer instructions are executed by a processor, the processor executes a method comprising: obtaining encoding data of a video, and obtaining video data by performing a decoding process corresponding to an encoding process on the encoding data, wherein the encoding process includes: obtaining current template reconstruction data, the current template reconstruction data including reconstruction pixel data of a current template region in a current frame related to a current encoding block; obtaining reference template reconstruction data, the reference template reconstruction data including reconstruction pixel data of a reference template region in a reference frame related to a reference encoding block, the current template region corresponding to the reference template region; obtaining a prediction value adjustment model of the current encoding block based on the current template reconstruction data and the reference template reconstruction data; obtaining an initial prediction value of the current encoding block, and determining a target prediction value by adjusting, based on the initial prediction value, the initial prediction value according to the prediction value adjustment model; and determining encoding data of the current encoding block based on the target prediction value.

Possible beneficial effects of the embodiments of the present disclosure include but are not limited to: (1) By determining a target prediction value based on a prediction value adjustment model of a current encoding block, an encoder encodes only an adopted prediction mode and residuals calculated when such prediction mode is adopted, then a decoding end can decode a corresponding pixel value based on stream information, which greatly reduces code words required for encoding. At the same time, in the prediction mode, when obtaining a current template region, features of the current encoding block are considered, so that a more accurate target prediction value of each encoding block can be determined during encoding, and a more accurate restored pixel value of each encoding block can be obtained when decoding, which improves the effect of encoding and decoding, and reduce the loss caused by a video encoding and decoding. (2) By determining a candidate target prediction value of each pixel in a region with the smallest cost value in a first template region, a second template region, and a third template region as a target prediction value of each pixel, so that a target prediction value of a pixel in the current encoding block is also a prediction value of the pixel in a template that has the greatest influence on the current encoding block. (3) For any current encoding pixel type, its matching target prediction value adjustment model can accurately reflect a lighting relationship between current encoding pixels in a current encoding pixel type and corresponding pixels in a reference encoding block, so by using the prediction adjustment model to predict each current encoding pixel in the current encoding pixel type separately, this can ensure the accuracy of predicting the current encoding pixels, and finally achieve the purpose of optimizing the visual effect of the image. (4) By adjusting a preset function according to an actual need, a gap between representative values corresponding to two reference template pixels can be smaller than the gap between absolute values corresponding to the two reference template pixels, or the gap between the representative values corresponding to the two reference template pixels can be bigger than the gap between the absolute values corresponding to the two reference template pixels, so that a solution is flexible and can meet various actual needs. (5) Since the greater a difference between a reconstruction pixel value of the reference template pixel and a reconstruction pixel value of a reference encoding pixel is, the greater a proportion of a reconstruction pixel value of a corresponding current template pixel is in the obtained target prediction value, so that a difference between a target prediction value of the current encoding pixel and the reconstruction pixel value of the current template pixel can be reduced, avoiding a jump of a pixel value between pixels. (6) A plurality of candidate reference regions including an initial reference region is generated by performing a translation process on the initial reference region in a reference frame, and then a reference encoding block most similar to the current encoding block among reference encoding blocks corresponding to the plurality of candidate reference regions is determined. Compared with the prior art where an initial reference encoding block is directly used as the reference encoding block, the above manner in the present disclosure can avoid errors when determining the initial reference encoding block which affects the accuracy of subsequent results. (7) Considering that errors may occur when determining the initial reference region, the above process can determine a target prediction value of any pixel in the reference encoding lock most similar to the current encoding block as a target prediction value of the pixel. (8) When constructing a prediction model, it is no longer only based on an initial reference template pixel, but simultaneously combines reconstruction pixel values of pixels surrounding the initial reference template pixel and a plurality of reconstruction pixel values of the initial reference template pixel. Therefore, the accuracy rate of the prediction value adjustment model constructed can be improved, the accuracy rate of the final prediction of the current encoding pixel can be improved, and the effect of final image transmission can be guaranteed. (9) After an initial current template region and an initial reference template region are determined, a processing device may determine a common region of the initial current template region and the initial reference template region as the current template region and the reference template region. While making full use of space information, the above manner avoids the problem that reconstruction pixels that can be obtained in the initial current template region outside the current encoding block cannot correspond to reconstruction pixels that can be obtained in the initial reference template region outside the reference encoding block, ensuring the accuracy of the final prediction result. (10) Combining a luma block and a chrome block to determine the target prediction value can improve the accuracy of prediction and ensure the effect of final image transmission. (11) Determining the target prediction value through a cost value of at least one initial target prediction value obtained based on at least one processing mode, so that a more accurate target prediction value can be determined.

The basic concept has been described above, obviously, for those skilled in the art, the above-detailed disclosure is only an example and does not constitute a limitation to the present disclosure. Although not expressly stated here, those skilled in the art may make various modifications, improvements, and corrections to the present disclosure. Such modifications, improvements, and corrections are suggested in the present disclosure, so such modifications, improvements, and corrections still belong to the spirit and scope of the exemplary embodiments of the present disclosure.

Meanwhile, the present disclosure uses specific words to describe the embodiments of the present disclosure. For example, “one embodiment”, “an embodiment”, and/or “some embodiments” refer to a certain feature, structure, or characteristic related to at least one embodiment of the present disclosure. Therefore, it should be emphasized and noted that two or more references to “an embodiment” “one embodiment” or “an alternative embodiment” in different places in the present disclosure do not necessarily refer to the same embodiment. In addition, certain features, structures, or characteristics in one or more embodiments of the present disclosure may be properly combined.

In addition, unless explicitly stated in the claims, the order of processing elements and sequences described in the present disclosure, the use of numbers and letters, or the use of other names are not used to limit the sequence of processes and methods in the present disclosure. While the foregoing disclosure has discussed by way of various examples some embodiments of the invention that are presently believed to be useful, it should be understood that such detail is for illustrative purposes only and that the appended claims are not limited to the disclosed embodiments, but rather, the claims are intended to cover all modifications and equivalent combinations that fall within the spirit and scope of the embodiments of the present disclosure. For example, although the implementation of various components described above may be embodied in a hardware device, it may also be implemented as a software only solution, e.g., an installation on an existing server or mobile device.

In the same way, it should be noted that in order to simplify the expression disclosed in the present disclosure and help the understanding of one or more embodiments of the invention, in the foregoing description of the embodiments of the present disclosure, sometimes multiple features are combined into one embodiment, drawings, or descriptions thereof. This manner of disclosure does not, however, imply that the subject matter of the present disclosure requires more features than are recited in the claims. Rather, claimed subject matter may lie in less than all features of a single foregoing disclosed embodiment.

In some embodiments, numbers describing the quantity of components and attributes are used, and it should be understood that such numbers used in the description of the embodiments use the modifiers “about”, “approximately” or “substantially” in some embodiments. Unless otherwise stated, “about”, “approximately” or “substantially” indicates that the stated figure allows for a variation of +20%. Accordingly, in some embodiments, the numerical parameters used in the present disclosure and claims are approximations that can vary depending on the desired characteristics of individual embodiments. In some embodiments, numerical parameters should take into account the specified significant digits and adopt a general digit reservation manner. Although the numerical ranges and parameters used in some embodiments of the present disclosure to confirm the breadth of the range are approximations, in specific embodiments, such numerical values should be set as precisely as practicable.

Each patent, patent application, patent application publication, and other material, such as article, book, specification, publication, document, etc., cited in the present disclosure is hereby incorporated by reference in its entirety. Historical application documents that are inconsistent with or conflict with the content of the present disclosure are excluded, and documents (currently or later appended to the present disclosure) that limit the broadest scope of the claims of the present disclosure are excluded. It should be noted that if there is any inconsistency or conflict between the descriptions, definitions, and/or terms used in the accompanying materials of the present disclosure and the contents of the present disclosure, the descriptions, definitions, and/or terms used in the present disclosure shall prevail.

Finally, it should be understood that the embodiments described in the present disclosure are only used to illustrate the principles of the embodiments of the present disclosure. Other possible modifications are also within the scope of the present disclosure. Therefore, by way of example and not limitation, alternative configurations of the embodiments of the present disclosure may be considered consistent with the teachings of the present disclosure. Accordingly, the embodiments of the present disclosure are not limited to the embodiments explicitly introduced and described in the present disclosure.

1. A video encoding method, comprising:
obtaining current template reconstruction data, the current template reconstruction data including reconstruction pixel data of a current template region in a current frame related to a current encoding block;
obtaining reference template reconstruction data, the reference template reconstruction data including reconstruction pixel data of a reference template region in a reference frame related to a reference encoding block, the current template region corresponding to the reference template region;
obtaining a prediction value adjustment model of the current encoding block based on the current template reconstruction data and the reference template reconstruction data;
obtaining an initial prediction value of the current encoding block;
determining a target prediction value by adjusting, based on the initial prediction value, the initial prediction value according to the prediction value adjustment model; and
determining encoding data of the current encoding block based on the target prediction value.

2. The method of claim 1, wherein
the reference template reconstruction data includes a reconstruction pixel value of each of at least one reference template pixel and the current template reconstruction data includes a reconstruction pixel value of each of at least one current template pixel; and
the obtaining the prediction value adjustment model of the current encoding block based on the current template reconstruction data and the reference template reconstruction data includes:
determining at least one reference pixel type by classifying the at least one reference template pixel based on a preset classification rule;
for each of the at least one reference template pixel type,
constructing the prediction value adjustment model corresponding to the reference template pixel type based on the reference template reconstruction data in the reference template pixel type and the corresponding current template reconstruction data, wherein the corresponding current template reconstruction data includes a reconstruction pixel value of a current template pixel corresponding to a position of the reference template pixel in the current template.

3. The method of claim 2, wherein the determining the target prediction value by adjusting, based on the initial prediction value, the initial prediction value according to the prediction value adjustment model includes:
the initial prediction value of the current encoding block including an initial prediction value of at least one current encoding pixel, determining at least one encoding pixel type by classifying the at least one current encoding pixel based on the preset classification rule;
for each of the at least one current encoding pixel type,
determining the reference template pixel type matched by the current encoding pixel type; and
determining the target prediction value of the current encoding pixel in the current encoding pixel type based on the initial prediction value of the current encoding pixel in the current encoding pixel type, the prediction value adjustment model corresponding to the matching reference template pixel type.

4. The method of claim 1, wherein the current template region is determined by:
designating a pixel region formed by at least one pixel column along a direction pointed out from an outside of the current encoding block as the current template region, the at least one pixel column starting from an adjacent pixel column of the current encoding block on the outside; and/or
designating a pixel region formed by at least one pixel row along a direction pointed out from an outside of the current encoding block as the current template region, the at least one pixel row starting from an adjacent pixel row of the current encoding block on the outside.

5. The method of claim 4, wherein a count of the at least one pixel column is positively correlated with a size of the current encoding block; and/or
a count of the at least one pixel row is positively correlated with the size of the current encoding block.

6. The method of claim 4, wherein the current template region is further determined by:
extracting, a portion of current template pixels from the pixel region formed by the at least one pixel column and/or the pixel region formed by the at least one pixel row; and
constructing the current template region using the portion of the current template pixels.

7. The method of claim 1, wherein the determining the target prediction value by adjusting, based on the initial prediction value, the initial prediction value according to the prediction value adjustment model includes:
obtaining, based on at least one of processing modes, at least one initial target prediction value of the current encoding block; and
determining, based on a cost value of the at least one initial target prediction value, the target prediction value.

8. (canceled)

9. The method of claim 1, wherein the initial prediction value of the current encoding block includes an initial prediction value of each of at least one current encoding pixel, the obtaining the prediction value adjustment model of the current encoding block includes:
the current encoding block includes a plurality of current encoding pixels, for each of the plurality of current encoding pixels:
obtaining, based on a reconstruction pixel value, reference template reconstruction data, and current template reconstruction data of a reference encoding pixel corresponding to the current encoding pixel in the reference encoding block, a prediction value adjustment model of the current encoding pixel.

10. The method of claim 9, wherein the determining the target prediction value by adjusting, based on the initial prediction value, the initial prediction value by the prediction value adjustment model includes:
for each of the plurality of current encoding pixels, determining a target prediction value of the current encoding pixel by adjusting, based on an initial prediction value of the current encoding pixel, the initial prediction value of the current encoding pixel according to the prediction value adjustment model of the current encoding pixel.

11-12. (canceled)

13. The method of claim 9, wherein the obtaining, based on the reconstruction pixel value, the reference template reconstruction data, and the current template reconstruction data of the reference encoding pixel corresponding to the current encoding pixel in the reference encoding block, the prediction value adjustment model of the current encoding pixel includes:
for each of the at least one reference template pixel,
designating an absolute value of a difference between a reconstruction pixel value of the reference template pixel and a reconstruction pixel value of the reference coded pixel as an absolute value corresponding to the reference template pixel;
inputting the absolute value corresponding to the reference template pixel into a preset function to obtain a representative value corresponding to the reference template pixel, wherein the representative value corresponding to the reference template pixel and the absolute value corresponding to the reference template pixel are positively correlated; and
determining, based on the representative value corresponding to the reference template pixel, an adjustment coefficient corresponding to the reference template pixel, wherein the adjustment coefficient corresponding to the reference template pixel and the representative value corresponding to the reference template pixel are positively correlated.

14. (canceled)

15. The method of claim 1, wherein the method further includes:
determining a reference region in a reference frame, the reference region including a reference encoding block and/or a reference template region;
wherein the determining the reference region includes:
determining an initial reference region in the reference frame based on an initial motion vector corresponding to the current encoding block;
obtaining a plurality of candidate reference regions including the initial reference region by performing a translation process on the initial reference region in the reference frame; and
determining the reference region among the plurality of candidate reference regions.

16. The method of claim 15, wherein the encoded data includes:
a syntactic element indicative of a translation parameter between the reference region and the initial reference region.

17. The method of claim 1, wherein the method further includes:
obtaining a plurality of candidate current template regions of the current encoding block; and
selecting, based on a target feature of the current encoding block, at least one of a combination of the plurality of candidate current template regions as the current template region.

18. The method of claim 1, wherein the encoded data includes: a syntactic element indicative of a type of the current template region.

19. The method of claim 1, wherein
the prediction value adjustment model includes a non-linear model;
the initial prediction value of the current encoding block includes an initial prediction value of a current encoding pixel;
the determining the target prediction value by adjusting, based on the initial prediction value, the initial prediction value according to the prediction value adjustment model includes:
determining the target prediction value by adjusting, based on the initial prediction value of the current encoding pixel and a plurality of current encoding pixel values corresponding to the current encoding pixel, the initial prediction value according to the prediction value adjustment model; and
the plurality of current encoding pixel values including a reconstruction pixel value of an initial reference encoding pixel and reconstruction pixel values of pixels surrounding the f initial reference encoding pixel, the first target pixel being a pixel in a reference encoding block corresponding to the current encoding pixel.

20. The method of claim 19, wherein the current template includes a plurality of current template pixels in the current frame and the reference template includes a plurality of reference template pixels in the reference frame;
the prediction value adjustment model is determined by:
for each of the at least one current template pixel, constructing a prediction value adjustment model based on a reconstruction pixel value of the current template pixel and reconstruction pixel values corresponding to the plurality of reference template pixels;
wherein the reconstruction pixel values of the plurality of reference template pixels include a plurality of values of reconstruction pixel values of pixels around an initial reference template pixel and a reconstruction pixel value of the initial reference template pixel, the initial reference template pixel being a pixel in the reference template corresponding to the current template pixel.

21. The method of claim 1, further comprising:
determining an initial current template region of the current encoding block in the current frame and an initial reference module region of the reference encoding block in the reference frame;
determining a common region of the initial current template region and the initial reference template region; and
determining the current template region and the reference template region based on the common region.

22. The method of claim 1, wherein the current encoding block includes a first encoding block and a second encoding block, the first encoding block being a first color component block and the second encoding block being a second color component block, and the method further includes at least one of:
obtaining a target prediction value of the first encoding block,
constructing a prediction value adjustment model of the second encoding block based on the reconstruction pixel data of the current template region of the first encoding block and reconstruction pixel data in a current template region of the second encoding block, and
obtaining a target prediction value of the second encoding block based on a prediction value adjustment model of the second encoding block and a target prediction value of the first encoding block;
obtaining a target prediction value of the first encoding block,
constructing a prediction value adjustment model of the second encoding block based on a reconstructed pixel value of a reference encoding block of the first encoding block and a target prediction value of the first encoding block, and
obtaining a target prediction value of the second encoding block based on a prediction value adjustment model of the second encoding block and a reconstructed pixel value of a reference encoding block of the second encoding block; or
obtaining a target prediction value of the first encoding block,
constructing a prediction value adjustment model of the second encoding block based on reconstruction pixel data of a reference encoding block of the first encoding block and reconstruction pixel data of a reference encoding block of the second encoding block, and
obtaining a target prediction value of the second encoding block based on a prediction value adjustment model of the second encoding block, a target prediction value of the first encoding block.

23. A video encoding system, comprising:
at least one storage medium, the storage medium including an instruction set for a video encoding;
at least one processor, the at least one processor being in communication with the at least one storage medium, wherein, when executing the instruction set, the at least one processor is configured to:
obtain current template reconstruction data, the current template reconstruction data including reconstruction pixel data of a current template region in a current frame related to a current encoding block;
obtain reference template reconstruction data, the reference template reconstruction data including reconstruction pixel data of a reference template region in a reference frame related to a reference encoding block, the current template region corresponding to the reference template region;
obtain a prediction value adjustment model of the current encoding block based on the current template reconstruction data and the reference template reconstruction data;
obtain an initial prediction value of the current encoding block;
determine a target prediction value by adjusting, based on the initial prediction value, the initial prediction value according to the prediction value adjustment model; and
determine encoding data of the current encoding block based on the target prediction value.

24. (canceled)

25. A video decoding method, comprising:
obtaining encoding data of a video, and obtaining video data by performing a decoding process corresponding to an encoding process on the encoding data, the encoding process including:
obtaining current template reconstruction data, the current template reconstruction data including reconstruction pixel data of a current template region in a current frame related to a current encoding block;
obtaining reference template reconstruction data, the reference template reconstruction data including reconstruction pixel data of a reference template region in a reference frame related to a reference encoding block, the current template region corresponding to the reference template region;
obtaining a prediction value adjustment model of the current encoding block based on the current template reconstruction data and the reference template reconstruction data;
obtaining an initial prediction value of the current encoding block;
determining a target prediction value by adjusting, based on the initial prediction value, the initial prediction value according to the prediction value adjustment model; and
determining encoding data of the current encoding block based on the target prediction value.

26-27. (canceled)
